(19) United States
(12) Patent Application Publication
(10) Pub. No.: US 2023/0404102 A1
(43) Pub. Date: Dec. 21, 2023

(54) EDIBLE MICROBIAL OIL

(71) Applicant: C16 Biosciences, Inc., New York, NY (US)

(72) Inventors: Harold M. MCNAMARA, New York, NY (US); Shara TICKU, New York, NY (US); David HELLER, New York, NY (US); Corentin MOEVUS, New York, NY (US)

(21) Appl. No.: 18/035,594

(22) PCT Filed: Nov. 12, 2021
(86) PCT No.: PCT/US2021/059122

§ 371 Date: May 5, 2023

Related U.S. Application Data
(60) Provisional application No. 63/112,849, filed on Nov. 12, 2020.

(51) Int. Cl. A23D 9/04; C11B 1/10; C11C 3/00; C11C 1/00; C11B 7/00; A23D 9/007; A23G 1/36; A21D 2/16; A23C 20/02; A23L 25/10; A23L 33/00; A23L 33/12; A23L 33/145

(52) U.S. Cl. CPC A23D 9/04; C11B 1/10; C11C 3/003; C11C 1/002; C11B 7/0075; A23D 9/007; A23G 1/36; A21D 2/165; A23C 20/025; A23L 25/10; A23L 33/40; A23L 33/12; A23L 33/145

(57) ABSTRACT

The present disclosure relates to a microbial oil and/or derivative thereof, wherein the oil is produced by an oleaginous yeast. The disclosure also relates to blended fat compositions comprising a vegetable oil and an edible microbial oil. The disclosure further relates edible microbial oils and derivatives, and to food products comprising an edible microbial oil and/or a derivative thereof, and/or a blended fat composition, and methods of producing such food products. The microbial oil may serve as vegetable oil alternatives and be processed and/or derivatized by any number of means known in the art.

### CROSS-REFERENCE TO RELATED APPLICATIONS

This application claims the benefit of U.S. Provisional Application No. 63/112,849 filed on Nov. 12, 2020, which is hereby incorporated by reference in its entirety for all purposes.

### FIELD OF THE DISCLOSURE

The present disclosure relates to environmentally friendly and sustainable alternatives to plant-derived oils, such as palm oil, for consumption and use in food products. The oil alternatives are produced by oleaginous microorganisms and share one or more features with plant-derived oils. These alternatives may also be fractionated, treated, and/or derivatized based on their intended use.

### BACKGROUND

Palm oil is currently the most widely produced vegetable oil on the planet, as it finds uses in the manufacture of a large variety of products. It is widely used in food; approximately 30% of all vegetable oil produced worldwide is palm oil. Due to its unique properties, 70-90% of the palm oil produced is used in the food industry, either as a cooking oil or as a derivative in processed food. In an average grocery store, as many as 50% of the products sold have palm oil or a derivative as an ingredient. The global demand for palm oil is approximately 57 million tons and is steadily increasing. However, the high demand for palm oil has resulted in environmentally detrimental practices related to the expansion of plantations devoted to palm oil-producing plants. Palm oil production is a leading contributor to tropical deforestation, resulting in habitat destruction, increased carbon dioxide emissions, and local smog clouds across South East Asia.

Thus, there is an urgent need for palm oil alternatives that do not rely upon utilization of oil palms and incur the associated negative environmental costs.

### BRIEF SUMMARY

The present disclosure relates to microbial oils and/or derivative thereof, wherein the microbial oil is produced by an oleaginous yeast. In some embodiments, the microbial oil and/or derivative thereof further comprises ergosterol, β-carotene, torulene, and/or torularhodin. In some embodiments, the microbial oil and/or derivative thereof comprises at least 50 ppm ergosterol. In some embodiments, the microbial oil and/or derivative thereof of is produced by Rhodosporidium toruloides.

In some embodiments, the microbial oil comprises a fatty acid profile comprising greater than 30% saturated fatty acids; greater than 30% mono-unsaturated fatty acids; and less than 30% poly-unsaturated fatty acids. In some embodiments, the microbial oil comprises a saturated fatty acid composition of at least 40%. In some embodiments, the microbial oil comprises an unsaturated fatty acid composition of at least 40%. In some embodiments, the microbial oil comprises a triglyceride composition wherein at least 40% of the triglycerides have one unsaturated sidechain; and at least 30% of the triglycerides have two unsaturated sidechains. In some embodiments, the triglyceride molecules comprise between 10% and 15% of palmitic and/or stearic fatty acids at the sn-2 position.

In some embodiments, the microbial oil derivative is a fraction, and the fraction is microbial stearin, microbial olein, microbial soft mid-fraction, microbial super olein, microbial hard mid-fraction, microbial olein, and/or microbial top olein.

In another embodiment, the present disclosure relates to a food product comprising an edible microbial oil and/or derivative thereof. In some embodiments, the food product comprises between 0.1% and 30% edible microbial oil and/or derivative thereof. In some embodiments, the food product is a nut butter or spread. In some embodiments, the food product is a chocolate product or a chocolate countline product. In some embodiments, the food product is a baked good. In some embodiments, the food product is a meat substitute, and the edible microbial oil is used as a substitute for animal fat. In some embodiments, the meat substitute is a ground-beef-like product. In some embodiments, the food product is a cheese-like substance. In some embodiments, the food product is a milk-like product. In some embodiments, the food product is an infant formula. In some embodiments, the food product does not comprise palm oil or palm kernel oil. In some embodiments, the food product does not comprise animal fat.

In another embodiment, the present disclosure relates to a blended fat composition, wherein the composition comprises a vegetable oil lipid source, and at least 1% edible microbial oil and/or derivative thereof. In some embodiments, the vegetable oil lipid is soybean oil, corn oil, rapeseed oil, canola oil, sunflower oil, safflower oil, coconut oil, rice bran oil, olive oil, sesame oil, flaxseed oil, hemp oil, or cottonseed oil. In some embodiments, the vegetable oil lipid is peanut oil, almond oil, beech nut oil, brazil nut oil, cashew oil, hazelnut oil, macadamia oil, mongongo nut oil, pecan oil, pine nut oil, pistachio oil, walnut oil, or pumpkin seed oil. In some embodiments, the vegetable oil lipid is grapefruit seed oil, lemon oil, apricot oil, apple seed oil, argan oil, avocado oil, or orange oil. In some embodiments, the blended fat composition is a cooking oil, frying oil, shortening, margarine, or butter-like product. In some embodiments, the blended fat composition does not comprise palm oil or palm kernel oil.

In another embodiment, the present disclosure relates to a palm oil substitute comprising an edible microbial oil and/or derivative thereof or a blended fat composition comprising a vegetable oil lipid source, and at least 1% edible microbial oil and/or derivative thereof. In some embodiments, the palm oil substitute has one or more characteristics similar to plant-derived palm oil selected from the group consisting of: apparent density, refractive index, oxidative stability, saponification value, unsaponifiable matter, iodine value, slip melting point, fatty acid composition, triglyceride content, overall saturation level, and level of mono- and poly-unsaturated fatty acids. In some embodiments, the palm oil substitute comprises a slip melting point of 30° C.-40° C. In some embodiments, the palm oil substitute is stearin, and the stearin has a slip melting point of greater than 25° C.

In another embodiment, the present disclosure relates to a meat fat substitute comprising an edible microbial oil and/or derivative thereof or a blended fat composition comprising a vegetable oil lipid source, and at least 1% edible microbial oil and/or derivative thereof. In some embodiments, the meat fat substitute further comprises at least one of an edible gum, a starch, and a gelling agent.

In another embodiment, the present disclosure teaches a method for producing an edible microbial oil comprising obtaining a whole cell or lysed microbial biomass; and extracting crude microbial oil from the whole cell or lysed microbial biomass, wherein said extraction process removes toxins and produces a microbial oil safe for human consumption. In some embodiments, the method further comprises processing the microbial oil, wherein the processing comprises physical refining, chemical refining, deodorizing, bleaching, and combinations thereof. In some embodiments, the method further comprises modifying the microbial oil, wherein the modifying comprises fractionation, interesterification, transesterification, hydrogenation, steam hydrolysis, distillation, saponification, or combinations thereof. In some embodiments, the derivative is a triglyceride, diglyceride, monoglyceride, free fatty acid, fatty acid salt, glycerin, ester, fatty alcohol, derivative thereof, or combination thereof.

In some embodiments, the disclosure teaches a method for producing a food product comprising: obtaining an edible microbial oil, and/or a derivative thereof, wherein said oil is produced from an oleaginous yeast; using the microbial oil and/or derivative thereof as an ingredient in a food product; and producing a food product. In some embodiments, the food product is a nut butter or spread, a chocolate product, a baked good, a meat substitute, a cheese-like product, a milk-like product, an infant formula, a cooking oil, shortening, margarine, or butter-like product.

### BRIEF DESCRIPTION OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIG. 1 is a flow diagram illustrating examples of various methods of processing the microbial oil and the resulting derivatives (oleochemicals) which may be used in the food industry.

FIG. 2A shows a chromatogram of the triglyceride composition analysis of exemplary crude microbial oil; FIG. 2B shows a chromatogram of the triglyceride composition analysis of exemplary crude palm oil; and FIG. 2C shows a chromatogram of the triglyceride composition analysis of exemplary crude hybrid palm oil.

FIG. 3 is a flow diagram of fractions produced from microbial oil.

FIG. 4A is a photograph of a fractionation of crude microbial oil (left) and crude palm oil (right). FIG. 4B is a photograph of a complete fractionation of crude microbial oil. FIG. 4C is a photograph of an incomplete fractionation of crude microbial oil.

FIG. 5 is a bar graph showing gas chromatography-mass spectrometry (GCMS) data highlighting how the fractionation shifts the fatty acid profile in the olein and stearin layers.

FIG. 6 is a bar graph of the data shown in FIG. 5 illustrating the overall balance of saturated fatty acids (SFA), monounsaturated fatty acids (MUFA), and polyunsaturated fatty acids (PUFA).

FIG. 7A shows a chromatogram of the fatty acid composition analysis of exemplary crude microbial oil; FIG. 7B shows a chromatogram of the fatty acid composition analysis of exemplary crude palm oil; FIG. 7C shows a chromatogram of the fatty acid composition analysis of exemplary crude hybrid palm oil; and FIG. 7D shows a bar graph of representative fatty acid compositions of microbial oil and palm oil.

FIG. 8 is a flow diagram of fatty acids produced from microbial oil.

FIG. 9 is a flow diagram of fatty alcohols produced from microbial oil.

FIG. 10 shows a chromatogram of the tocopherols analysis of exemplary crude microbial oil, crude palm oil, and crude hybrid palm oil. Notable peaks are annotated, with “External ISTD” illustrating the location of the standard.

FIG. 11A-11D shows pictures of peanut butter made with edible microbial oil.

FIG. 12 shows a picture of cookies make with edible microbial oil.

FIG. 13 shows a picture of biscuits made with palm oil (left) and edible microbial oil (right).

FIG. 14A-14C show pictures of a meat substitute burger made with edible microbial oil.

FIG. 14D-14D show pictures of a meat substitute burger made with palm oil.

FIG. 15 shows a picture of a chocolate spread made with palm oil (left) and edible microbial oil (right).

### DETAILED DESCRIPTION

The following description includes information that may be useful in understanding the present disclosure. It is not an admission that any of the information provided herein is prior art or relevant to the presently claimed disclosures, or that any publication specifically or implicitly referenced is prior art.

### Definitions

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques and/or substitutions of equivalent techniques that would be apparent to one of skill in the art.

As used herein, the singular forms “a,” “an,” and “the: include plural referents unless the content clearly dictates otherwise.

The term “about” or “approximately” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, an “edible microbial oil” is an oil produced by or isolated from a microorganism which is safe for human consumption.

A “fatty acid” is a carboxylic acid with a long aliphatic chain, which is either saturated or unsaturated. Most naturally occurring fatty acids have an unbranched chain of an even number of carbon atoms, from 4 to 28. Fatty acids are usually not found free in organisms, but instead within three main classes of esters: triglycerides, phospholipids, and cholesteryl esters. Within the context of this disclosure, a reference to a fatty acid may refer to either its free or ester form.

“Fatty acid profile” as used herein refers to how specific fatty acids contribute to the chemical composition of an oil.

As used herein, the term “fractionable” is used to refer to a microbial oil or lipid composition which can be separated into at least two fractions that differ in saturation levels and wherein the at least two fractions each make up at least 10% w/w (or mass/mass) of the original microbial oil or lipid composition. The saturation levels of the fractions may be characterized by, e.g., their iodine value (IV). The IV of the fractions may differ by at least 10. Accordingly, a “fraction” as used herein refers to a separable component of a microbial oil that differs in saturation level from at least one other separable component of the microbial oil.

“Lipid” means any of a class of molecules that are soluble in nonpolar solvents (such as ether and hexane) and relatively or completely insoluble in water. Lipid molecules have these properties, because they are largely composed of long hydrocarbon tails that are hydrophobic in nature. Examples of lipids include fatty acids (saturated and unsaturated); glycerides or glycerolipids (such as monoglycerides, diglycerides, triglycerides or neutral fats, and phosphoglycerides or glycerophospholipids); and nonglycerides (sphingolipids, tocopherols, tocotrienols, sterol lipids including cholesterol and steroid hormones, prenol lipids including terpenoids, fatty alcohols, waxes, and polyketides).

“Microorganism” and “microbe” mean any microscopic unicellular organism and can include bacteria, algae, yeast, or fungi.

“Oleaginous” as used herein refers to material, e.g., a microorganism, which contains a significant component of oils, or which is itself substantial composed of oil. An oleaginous microorganism can be one that is naturally occurring or synthetically engineered to generate a significant proportion of oil.

“Oleaginous yeast” as used herein refers to a collection of yeast species that can accumulate a high proportion of their biomass as lipids (namely greater than 20% of dry cell mass). An oleaginous yeast can be one that is naturally occurring or synthetically engineered to generate a significant proportion of oil.

As used herein, “RBD” refers to refinement, bleaching, and deodorizing or refers to an oil that has undergone these processes.

“Rhodosporidium toruloides” refers to a particular species of oleaginous yeast. Previously called Rhodotorula glutinis or Rhodotorula gracilis. Also abbreviated as R. toruloides. This species includes multiple strains with minor genetic variation.

For the purposes of this disclosure, “single cell oils,” “microbial oils,” “lipid composition” and “edible microbial oil” refer to microbial lipids produced by oleaginous microorganisms.

“Surfactants” as used herein refers to a broad category of compounds that lower the surface tension between two liquids, for example oil and water, between a gas and a liquid, or between a liquid and a solid. In some instances, they can act as an emulsifier and/or a preservative.

“Tailored fatty acid profile” as used herein refers to a fatty acid profile in a microbial oil which has been manipulated towards target properties, either by changing culture conditions, the species of oleaginous microorganism producing the microbial oil, or by genetically modifying the oleaginous microorganism.

“Triglyceride(s)” as used herein refers to a glycerol bound to three fatty acid molecules. They may be saturated or unsaturated, and various denominations may include other isomers. For example, reference to palmitic-oleic-palmitic (P-O-P) would also include the isomers P-P-O and O-P-P.

“W/W” or “w/w”, in reference to proportions by weight, refers to the ratio of the weight of one substance in a composition to the weight of the composition. For example, reference to a composition that comprises 5% w/w oleaginous yeast biomass means that 5% of the composition's weight is composed of oleaginous yeast biomass (e.g., such a composition having a weight of 100 mg would contain 5 mg of oleaginous yeast biomass) and the remainder of the weight of the composition (e.g., 95 mg in the example) is composed of other ingredients.

### Overview

The present disclosure relates to an edible microbial oil and/or derivative thereof, wherein the oil is produced by an oleaginous yeast. The disclosure also relates to blended fat compositions comprising a vegetable oil and an edible microbial oil. The disclosure further relates to food products comprising an edible microbial oil or derivative thereof, and methods of producing food products comprising an edible microbial oil and/or derivative thereof. These lipids may serve as vegetable oil alternatives and be processed and/or derivatized by any number of means known in the art. For example, the edible microbial oil and/or derivative thereof may be a triglyceride, diglyceride, monoglyceride, free fatty acid, fatty acid salt, glycerol, ester, fatty alcohol, fatty amine, derivatives thereof, and combinations thereof. In some embodiments, the edible microbial oil or derivative thereof may be used in a variety of food products, including, for example, nut butters and spreads, chocolate products, baked goods, meat substitutes, and dairy substitutes. In some embodiments, the food product may be animal feed or pet food. In some embodiments, the blended fat composition may be used as a cooking oil, frying oil, shortening, margarine, or butter-like product.

### Oleaginous Microorganisms

An embodiment of the present disclosure relates to an edible microbial oil, or derivative thereof, derived from an oleaginous microorganism.

The use of oleaginous microorganisms for lipid production has many advantages over traditional oil harvesting methods, e.g., palm oil harvesting from palm plants. For example, microbial fermentation (1) does not compete with food production in terms of land utilization; (2) can be carried out in conventional microbial bioreactors; (3) has rapid growth rates; (4) is unaffected or minimally affected by space, light, or climate variations; (5) can utilize waste products as feedstock; (6) is readily scalable; and (7) is amenable to bioengineering for the enrichment of desired fatty acids or oil compositions. In some embodiments, the present methods have one or more of the aforementioned advantages over plant-based oil harvesting methods.

In some embodiments, the oleaginous microorganism is an oleaginous microalgae. In some embodiments, the microalgae is of the genus Botryococcus, Cylindrotheca, Nitzschia, or Schizochytrium. In some embodiments, the oleaginous microorganism is an oleaginous bacterium.

In some embodiments, the bacterium is of the genus Arthrobacter, Acinetobacter, Rhodococcus, or Bacillus. In some embodiments, the bacterium is of the species Acinetobacter calcoaceticus, Rhodococcus opacus, or Bacillus alcalophilus. In some embodiments, the oleaginous microorganism is an oleaginous fungus. In some embodiments, the fungus is of the genus Aspergillus, Mortierella, or Humicola. In some embodiments, the fungus is of the species Aspergillus oryzae, Mortierella isabellina, Humicola lanuginosa, or Mortierella vinacea.

Oleaginous yeast in particular are robust, viable over multiple generations, and versatile in nutrient utilization. They also have the potential to accumulate intracellular lipid content up to greater than 70% of their dry biomass. In some embodiments, the oleaginous microorganism is an oleaginous yeast. In some embodiments, the yeast may be in haploid or diploid forms. The yeasts may be capable of undergoing fermentation under anaerobic conditions, aerobic conditions, or both anaerobic and aerobic conditions. A variety of species of oleaginous yeast that produce suitable oils and/or lipids can be used to produce microbial lipids in accordance with the present disclosure. In some embodiments, the oleaginous yeast naturally produces high (20%, 25%, 50% or 75% of dry cell weight or higher) levels of suitable oils and/or lipids. Considerations affecting the selection of yeast for use in the invention include, in addition to production of suitable oils or lipids for production of food products: (1) high lipid content as a percentage of cell weight; (2) ease of growth; (3) ease of propagation; (4) ease of biomass processing; and (5) glycerolipid profile. In some embodiments, the oleaginous yeast comprise cells that are capable of producing at least 20%, 25%, 50% or 75% or more lipid by dry weight. In other embodiments, the oleaginous yeast contains at least 25-35% or more lipid by dry weight.

Suitable species of oleaginous yeast for producing the microbial lipids of the present disclosure include, but are not limited to Candida apicola, Candida sp., Cryptococcus albidus. Cryptococcus curvatus, Cryptococcus terricolus, Cutaneotrichosporon oleaginosus, Debaromyces hansenii, Endomycopsis vernalis, Geotrichum carabidarum, Geotrichum cucujoidarum, Geotrichum histeridarum, Geotrichum silvicola, Geotrichum vulgare, Hyphopichia burtonii, Lipomyces lipofer, Lypomyces orentalis, Lipomyces starkeyi, Lipomyces tetrasporous, Pichia mexicana, Rodosporidium sphaerocarpum, Rhodosporidium toruloides Rhodotorula aurantiaca, Rhodotorula dairenensis, Rhodotorula diffluens, Rhodotorula glutinus, Rhodotorula glutinis var. glutinis, Rhodotorula gracilis, Rhodotorula graminis Rhodotorula minuta, Rhodotorula mucilaginosa, Rhodotorula mucilaginosa, Rhodotorula terpenoidalis, Rhodotorula toruloides, Sporobolomyces alborubescens, Starmerella bombicola, Torulaspora delbruekii, Torulaspora pretoriensis, Trichosporon behrend, Trichosporon brassicae, Trichosporon domesticum, Trichosporon laibachii, Trichosporon loubieri, Trichosporon loubieri, Trichosporon montevideense, Trichosporon pullulans, Trichosporon sp., Wickerhamomyces canadensis, Yarrowia hpolytica, and Zygoascus meyerae.

In some embodiments, the yeast is of the genera Yarrowia, Candida, Rhodotorula, Rhodosporidium, Metschnikowia, Cryptococcus, Trichosporon, or Lipomyces. In some embodiments, the yeast is of the genus Yarrowia. In some embodiments, the yeast is of the species Yarrowia hpolytica. In some embodiments, the yeast is of the genus Candida. In some embodiments, the yeast is of the species Candida curvata. In some embodiments, the yeast is of the genus Cryptococcus. In some embodiments, the yeast is of the species Cryptococcus albidus. In some embodiments, the yeast is of the genus Lipomyces. In some embodiments, the yeast is of the species Lipomyces starkeyi. In some embodiments, the yeast is of the genus Rhodotorula. In some embodiments, the yeast is of the species Rhodotorula glutinis. In some embodiments, the yeast is of the genus Metschnikowia. In some embodiments, the yeast is of the species Metschnikowia pulcherrima.

In some embodiments, the oleaginous yeast is of the genus Rhodosporidium. In some embodiments, the yeast is of the species Rhodosporidium toruloides. In some embodiments, the oleaginous yeast is of the genus Lipomyces. In some embodiments, the oleaginous yeast is of the species Lipomyces starkeyi.

In some embodiments, the oleaginous microorganisms that produce the microbial lipids of the present disclosure are a homogeneous population comprising microorganisms of the same species and strain. In some embodiments, the oleaginous microorganisms that produce the microbial lipids of the present disclosure are a heterogeneous population comprising microorganisms from more than one strain. In some embodiments, the oleaginous microorganisms that produce the microbial lipids of the present disclosure are a heterogeneous population comprising two or more distinct populations of microorganisms of different species.

The oleaginous microorganisms that produce the microbial lipids used in the compositions of matter of the present disclosure may have been improved in terms of one or more aspects of lipid production. These aspects may include lipid yield, lipid titer, dry cell weight titer, lipid content, and lipid composition. In some embodiments, lipid production may have been improved by genetic or metabolic engineering to adapt the microorganism for optimal growth on the feedstock. In some embodiments, lipid production may have been improved by varying one or more parameters of the growing conditions, such as temperature, shaking speed, growth time, etc. The oleaginous microorganisms of the present disclosure, in some embodiments, are grown from isolates obtained from nature (e.g., wild-types). In some embodiments, wild-type strains are subjected to natural selection to enhance desired traits (e.g., tolerance of certain environmental conditions such as temperature, inhibitor concentration, pH, oxygen concentration, nitrogen concentration, etc.). For example, a wild-type strain (e.g., yeast) may be selected for its ability to grow and/or ferment in a feedstock of the present disclosure, e.g., a feedstock comprising one or more microorganism inhibitors. In other embodiments, wild-type strains are subjected to directed evolution to enhance desired traits (e.g., lipid production, inhibitor tolerance, growth rate, etc.). In some embodiments, the cultures of microorganisms are obtained from culture collections exhibiting desired traits. In some embodiments, strains selected from culture collections are further subjected to directed evolution and/or natural selection in the laboratory. In some embodiments, oleaginous microorganisms are subjected to directed evolution and selection for a specific property (e.g., lipid production and/or inhibitor tolerance). In some embodiments, the oleaginous microorganism is selected for its ability to thrive on a feedstock of the present disclosure.

In some embodiments, directed evolution of the oleaginous microorganisms generally involves three steps. The first step is diversification, wherein the population of organisms is diversified by increasing the rate of random mutation creating a large library of gene variants. Mutagenesis can be accomplished by methods known in the art (e.g., chemical, ultraviolet light, etc.). The second step is selection, wherein the library is tested for the presence of mutants (variants) possessing the desired property using a screening method. Screens enable identification and isolation of high-performing mutants. The third step is amplification, wherein the variants identified in the screen are replicated. These three steps constitute a “round” of directed evolution. In some embodiments, the microorganisms of the present disclosure are subjected to a single round of directed evolution. In other embodiments, the microorganisms of the present disclosure are subjected to multiple rounds of directed evolution. In various embodiments, the microorganisms of the present disclosure are subjected to 2, 3, 4, 5, 6, 7, 8, 9, 10, 20, 30, 40, 50, 60, 70, 80, 90, or 100 or more rounds of directed evolution. In each round, the organisms expressing the highest level of the desired trait of the previous round are diversified in the next round to create a new library. This process may be repeated until the desired trait is expressed at the desired level.

### Properties of Microbial Oil

The present disclosure provides edible microbial oils and/or derivatives thereof. These lipids may serve as alternatives or substitutes for vegetable oils, such as palm oil or palm kernel oil, meat fats, and dairy fats, and may be processed and/or derivatized by any number of means known in the art. The edible microbial oil and/or derivatives thereof may be used in a variety of downstream food products, and may further be blended with other fats and oils.

An embodiment of the present disclosure relates to an edible microbial oil and/or derivative thereof, wherein the edible microbial oil is derived from an oleaginous yeast. In some embodiments, the derivative is a triglyceride, diglyceride, monoglyceride, free fatty acid, fatty acid salt, glycerin, ester, fatty alcohol, fatty amine, derivatives thereof, or combination thereof.

### Sterol Composition

In some embodiments, the edible microbial oil comprises one or more sterols. In some embodiments, the edible microbial oil comprises ergosterol. In some embodiments, the edible microbial oil comprises at least 50 ppm ergosterol. In some embodiments, the edible microbial oil comprises at least 100 ppm ergosterol.

In some embodiments, the edible microbial oil comprises less than 100 ppm of a phytosterol, cholesterol, or a protothecasterol. In some embodiments, the edible microbial oil comprises less than 50 ppm of a phytosterol, cholesterol, or a protothecasterol. In some embodiments, the edible microbial oil does not comprise a sterol selected from a phytosterol, cholesterol, or a protothecasterol.

In some embodiments, the edible microbial oil does not comprise plant sterols. In some embodiments, the edible microbial oil does not comprise one or more phytosterols. In some embodiments, the edible microbial oil does not comprise campesterol, β-sitosterol, or stigmasterol. In some embodiments, the edible microbial oil does not comprise cholesterol. In some embodiments, the edible microbial oil does not comprise protothecasterol.

Pigments

In some embodiments, the edible microbial oil comprises a pigment. In some embodiments, the edible microbial oil comprises at least one pigment selected from the group consisting of carotene, torulene and torulorhodin. In some embodiments, the edible microbial oil comprises carotene. In some embodiments, the edible microbial oil comprises torulene. In some embodiments, the edible microbial oil comprises torulorhodin. In some embodiments, the edible microbial oil comprises each of carotene, torulene and torulorhodin. In some embodiments, the edible microbial oil does not comprise chlorophyll.

Fatty Acid Composition

The composition of the edible microbial oil may vary depending on the strain of microorganism, feedstock composition, and growing conditions. In some embodiments, the edible microbial oil derived from the oleaginous microorganisms of the present disclosure comprise about 90% w/w triacylglycerol with a percentage of saturated fatty acids (% SFA) of about 44%. The most common fatty acids produced by oleaginous microbial fermentation on the present feedstocks are oleic acid (C18:1), stearic acid (C18:0), palmitic acid (C16:0), palmitoleic acid (C16:1), and myristic acid (C14:0).

In some embodiments, the edible microbial oil comprises myristic acid (C14:0). In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, or at least 5% myristic acid.

In some embodiments, the edible microbial oil comprises at least 5%, at least 10%, at least 15%, at least 20%, at least 25%, at least 30%, at least 35%, at least 40%, at least 45%, at least 50%, at least 55%, or at least 60% w/w palmitic acid (C16:0). In some embodiments, the edible microbial oil comprises at least 5% w/w palmitic acid. In some embodiments, the edible microbial oil comprises at least 10% w/w palmitic acid. In some embodiments the edible microbial oil comprises 10-20% w/w palmitic acid. In some embodiments the edible microbial oil comprises 13-16% w/w palmitic acid.

In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9% or at least 10% w/w palmitoleic acid (C16:1). In some embodiments, the edible microbial oil comprises at least 0.1% w/w palmitoleic acid. In some embodiments, the edible microbial oil comprises at least 0.5% w/w palmitoleic acid. In some embodiments, the edible microbial oil comprises 0.5-10% w/w palmitoleic acid. In some embodiments, the edible microbial oil comprises 1-5% w/w palmitoleic acid.

In some embodiments, the edible microbial oil comprises margaric acid (C17:0). In some embodiments, the edible microbial oil comprises at least 1%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% margaric acid. In some embodiments, the edible microbial oil comprises 5-25% w/w margaric acid. In some embodiments, the edible microbial oil comprises 9-21% w/w margaric acid.

In some embodiments, the edible microbial oil comprises at least 1%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% w/w stearic acid (C18:0). In some embodiments, the edible microbial oil comprises at least 1% w/w stearic acid. In some embodiments, the edible microbial oil comprises at least 5% w/w stearic acid. In some embodiments, the edible microbial oil comprises 5-25% w/w stearic acid. In some embodiments, the edible microbial oil comprises 9-21% w/w stearic acid.

In some embodiments, the edible microbial oil comprises at least 5%, at least 10%, at least 15%, at least 20%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54% at least 55%, at least 56%, at least 57%, at least 58%, at least 59%, or at least 60% w/w oleic acid (C18:1). In some embodiments, the edible microbial oil comprises at least 25% w/w oleic acid. In some embodiments, the edible microbial oil comprises at least 30% w/w oleic acid. In some embodiments, the edible microbial oil comprises 30-65% w/w oleic acid. In some embodiments, the edible microbial oil comprises 39-55% w/w oleic acid.

In some embodiments, the edible microbial oil comprises C18:2 (linoleic acid). In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, or at least 5% linoleic acid.

In some embodiments, the edible microbial oil comprises C18:3 (linolenic acid). In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, or at least 5% linolenic acid.

In some embodiments, the edible microbial oil comprises C20:0 (arachidic acid). In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, or at least 5% arachidic acid.

In some embodiments, the edible microbial oil comprises C24:0 (lignoceric acid). In some embodiments, the edible microbial oil comprises at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, or at least 5% lignoceric acid.

In some embodiments, the edible microbial oil comprises C12:0. In some embodiments, the edible microbial oil comprises C15:1. In some embodiments, the edible microbial oil comprises C16:1. In some embodiments, the edible microbial oil comprises C17:1. In some embodiments, the edible microbial oil comprises C18:3. In some embodiments, the edible microbial oil comprises C20:1. In some embodiments, the edible microbial oil comprises C22:0. In some embodiments, the edible microbial oil comprises C22:1. In some embodiments, the edible microbial oil comprises C22:2. In some embodiments, the edible microbial oil comprises about 0.1%, about 0.2%, about 0.3%, about 0.4%, about 0.5%, about 0.6%, about 0.7%, about 0.8%, about 0.9%, about 1%, about 2%, about 3%, about 4%, or about 5% of any one of these fatty acids. In some embodiments, the edible microbial oil comprises about 0-5% of any one of these fatty acids. In some embodiments, the edible microbial oil comprises about 0.1-2% of any one of these fatty acids.

### Oxidative Stability

The unsaturated lipids in vegetable oils are susceptible to oxidation over time, which can be accelerated when the oil is exposed to heat, light, or metals. Oxidation causes changes in the chemical, sensory, and nutritional properties of the oil, and can result in, among other things, an unpleasant odor. In some embodiments, the microbial oil has a similar oxidative stability as other vegetable oils.

The oxidative stability of the microbial oil described herein was analyzed by detection of peroxide using methods known in the art, for example, by titration reaction of iodine and peroxide with a starch indicator. The peroxide value of the microbial oil was less than 2 mEq/kg, which is within the Malaysian Palm Oil Board (MPOB) specification.

### Characteristics Similar to Vegetable Oils

The present disclosure provides edible microbial oils and derivatives thereof. These lipids and derivatives may serve as alternatives or substitutes for vegetable oils, such as palm oil or palm kernel oil.

In some embodiments, the present disclosure provides environmentally friendly alternatives or substitutes for vegetable oils such as palm oil. In some embodiments, the edible microbial oil has one or more properties similar to those of plant-derived palm oil. Exemplary properties include apparent density, refractive index, oxidative stability, saponification value, unsaponifiable matter, iodine value, slip melting point, fatty acid composition, triglyceride content, overall saturation level, and level of mono- and poly-unsaturated fatty acids.

In some embodiments, the edible microbial oil has a fatty acid profile similar to that of plant-derived palm oil. In some embodiments, the edible microbial oil has a significant fraction of C16:0 fatty acid. In some embodiments, the edible microbial oil has a significant fraction of C18:1 fatty acid. In some embodiments, the edible microbial oil comprises 10-45% C16 saturated fatty acid. In some embodiments, the edible microbial oil comprises 10-70% C18 unsaturated fatty acid.

In some embodiments, the edible microbial oil has a similar ratio of saturated to unsaturated fatty acids as plant-derived palm oil. Some plant-derived palm oils have approximately 50% of each. In some embodiments, the edible microbial oil has a saturated fatty acid composition of about 50% and an unsaturated fatty acid composition of about 50%. In some embodiments, the edible microbial oil has a saturated fatty acid composition of about 40-60% and an unsaturated fatty acid composition of about 40-60%. In some embodiments, the edible microbial oil has a saturated fatty acid composition of about 30-70% and an unsaturated fatty acid composition of about 30-70%. In some embodiments, the edible microbial oil has about 30%, 35%, 40%, 45%, 50%, 55%, 60%, 65%, or 70% saturated fatty acids.

In some embodiments, the edible microbial oil has a similar level of mono-unsaturated fatty acids as plant-derived palm oil. Some plant-derived palm oils contain approximately 40% mono-unsaturated fatty acids. In some embodiments, the edible microbial oil contains about 40% mono-unsaturated fatty acids. In some embodiments, the edible microbial oil contains about 30-50% mono-unsaturated fatty acids. In some embodiments, the edible microbial oil contains about 5-60% mono-unsaturated fatty acids. In some embodiments, the edible microbial oil has about 5%, 10%, 15%, 20%, 25%, 30%, 35%, 40%, 45%, 50%, 55%, or 60% mono-unsaturated fatty acids.

In some embodiments, the edible microbial oil has a similar level of poly-unsaturated fatty acids as plant-derived palm oil. Some plant-derived palm oils contain approximately 10% poly-unsaturated fatty acids. In some embodiments, the edible microbial oil contains about 10% poly-unsaturated fatty acids. In some embodiments, the edible microbial oil contains about 5-25% poly-unsaturated fatty acids. In some embodiments, the edible microbial oil has about 5%, 6%, 7%, 8%, 9%, 10%, 11%, 12%, 13%, 14%, 15%, 16%, 17%, 18%, 19%, 20%, 21%, 22%, 23%, 24%, or 25% poly-unsaturated fatty acids.

In some embodiments, the edible microbial oil has a similar iodine value as plant-derived palm oil. Some plant-derived palm oils have an iodine value of about 50.4-53.7. In some embodiments, the edible microbial oil has an iodine value of about 49-65. In some embodiments, the edible microbial oil has an iodine value of about 49, 50, 51, 52, 53, 54, 55, 56, 57, 58, 59, 60, 61, 62, 63, 64, or 65.

Table 1 shows ranges for the fatty acid composition of an illustrative plant-derived palm oil and ranges of values for the fatty acid composition of illustrative microbial oil. In some embodiments, the edible microbial oil has one or more fatty acid composition parameters similar to those of Table 1. For example, in some embodiments, the edible microbial oil has a value within the plant-derived palm oil range for a given fatty acid composition parameter. In some embodiments, the edible microbial oil has a value within the edible microbial oil ranges provided in Table 1 for one or more parameters.

TABLE 1
Illustrative fatty acid compositions of microbial oil

| | Illustrative | Illustrative |
|---|---|---|
| | plant-derived | microbial oil |
| Component | palm oil range | range |
| C8:0 | 0.0-0.1% | 0.0% |
| C10:0 | 0.0-0.1% | 0.0-0.1% |
| C12:0 | 0.0-0.5% | 0.0-0.5% |
| C14:0 | 0.5-2.0% | 0.0-5.0% |
| C14:1c | 0.0-0.1% | 0.0-0.2% |
| C15:1 | 0.0-0.1% | 0.0-1.0% |
| C16:0 | 39.3-47.5% | 10.0-50.0% |
| C16:1 | 0.0-0.6% | 0.0-1.0% |
| C17:0 | 0.0-0.2% | 0.0-15.0% |
| C17:1 | 0.0-0.1% | 0.0-0.1% |
| C18:0 | 3.5-6.0% | 7.0-35.0% |
| C18:1 | 36.0-44.0% | 10.0-50.0% |
| C18:2 | 9.0-12.0% | 8.0-20.0% |
| C18:3 | 0.0-0.5% | 0.0-0.5% |
| C20:0 | 0.0% | 0.0-10.0% |
| C20:1 | 0.0-0.4% | 0.0-5.0% |
| C22:0 | 0.0-0.2% | 0.0-5.0% |
| C22:1 | 0.0% | 0.0-1.0% |
| C22:2 | 0.0% | 0.0-5.0% |
| C24:0 | 0.0% | 0.0-10.0% |

In some embodiments, the edible microbial oil has a similar slip melting point to plant-derived palm oil. Some plant-derived palm oils have a slip melting point of about 33.8-39.2° C. In some embodiments, the edible microbial oil has a slip melting point of about 20-40° C. In some embodiments, the edible microbial oil has a slip melting point of about 20, 21, 22, 23, 24, 25, 26, 27, 28, 29, 30, 31, 32, 33, 34, 35, 36, 37, 38, 39, or 40° C. In some embodiments, the derivative is stearin, and the stearin has a slip melting point of greater than 25° C.

In some embodiments, the edible microbial oil has a saponification value similar to that of plant-derived palm oil. Some plant-derived palm oils have a saponification value of about 190-209. In some embodiments, the edible microbial oil has a saponification value of about 150-210. In some embodiments, the edible microbial oil has a saponification value of about 150, 155, 160, 165, 170, 175, 180, 185, 190, 195, 200, 205, or 210.

In some embodiments, the edible microbial oil has a similar unsaponifiable matter content to that of plant-derived palm oil. Some plant-derived palm oils have an unsaponifiable matter content of about 0.19-0.44% by weight. In some embodiments, the edible microbial oil has an unsaponifiable matter content of less than 5% by weight.

In some embodiments, the edible microbial oil has a similar refractive index to that of plant-derived palm oil. Some plant-derived palm oils have a refractive index of about 1.4521-1.4541. In some embodiments, the edible microbial oil has a refractive index of about 1.3-1.6.

In some embodiments, the edible microbial oil has a similar apparent density to that of plant-derived palm oil. Some plant-derived palm oils have an apparent density of about 0.8889-0.8896. In some embodiments, the edible microbial oil has an apparent density of about 0.88-0.9.

In some embodiments, the edible microbial oil has one or more parameters similar to those of hybrid palm oil.

### Triglyceride Composition

Tables 2A and 2B show ranges for the triglyceride composition of an illustrative plant-derived palm oil and ranges of values for the triglyceride composition of illustrative microbial oil. The abbreviations used are as follows: S: Stearic fatty acid; P: Palmitic fatty acid; O: Oleic fatty acid. For each component shown below in Table 2A, for example P-O-P, the corresponding measurements for that molecule may also include other isomers, for example P-P-O and O-P-P. In some embodiments, the edible microbial oil has one or more triglyceride composition parameters similar to those of Table 2A and Table 2B. For example, in some embodiments, the edible microbial oil has a value similar to or within the plant-derived palm oil range for a given triglyceride composition parameter. For example, plant-derived palm oil has an O-O-P of approximately 23.24% and microbial-derived oil has an O-O-P of approximately 20.78.

In some embodiments, the edible microbial oil has a similar triglyceride content to that of plant-derived palm oil. For example, the total triglyceride content of sat-unsat-sat in plant-derived palm oil is approximately 49.53 and microbial-derived oil has approximately 49.42. In some embodiments, the edible microbial oil has a value different than plant-derived palm oil. For example, plant-derived palm oil has approximately 9.04% sat-sat-sat chains, whereas microbial-derived oil has approximately 3.36%. Some plant-derived palm oils have a triglyceride content of over 95%. In some embodiments, the edible microbial oil has a triglyceride content of 90-98%. In some embodiments, the edible microbial oil has a triglyceride content of about 90, 91, 92, 93, 94, 95, 96, 97, or 98%.

TABLE 2A
Illustrative triglyceride compositions of microbial oil

| | Crude plant- | Crude |
|---|---|---|
| | derived palm oil | microbial oil |
| Component | range | range |
| P-P-P | 6.48 +/− 1.62 | 1.02 +/− 0.25 |
| P-P-O | 31.62 +/− 7.9 | 22.53 +/− 5.63 |
| O-O-P | 23.24 +/− 5.81 | 20.78 +/− 5.12 |
| S-O-S | 0.6 +/− 0.15 | 1.53 +/− 0.38 |
| S-O-O | 2.46 +/− 0.62 | 4.29 +/− 1.07 |
| P-O-S | 6.11 +/− 1.53 | 10.25 +/− 2.56 |
| M-O-P | 1.58 +/− 0.40 | 4.73 +/− 1.18 |
| Sat-Sat-Sat | 9.04 +/− 1.36 | 3.36 +/− 0.50 |
| Sat-Unsat-Sat | 49.53 +/− 7.43 | 49.42 +/− 7.41 |
| Sat-Unsat-Unsat | 36.66 +/− 5.50 | 39.42 +/− 5.91 |
| Unsat-Unsat-Unsat | 4.77 +/− 0.72 | 6.86 +/− 1.03 |

TABLE 2B
Summary total triglyceride compositions

| | Number of unsaturated side chains | | | | |
|---|---|---|---|---|---|
| | 0 | 1 | 2 | 3 | total |
| Crude Plant-derived | 9.04% | 49.53% | 36.66% | 4.76887% | 100.00 |
| palm oil | | | | | |
| Crude Microbial- | 3.36% | 49.42% | 39.42% | 6.86% | 99.06 |
| derived oil | | | | | |

In some embodiments, the edible microbial oil has a similar diacylglycerol content as a plant-derived palm oil. Percentage of diacylglycerol varies between about 4-11% for some plant-derived palm oils. In some embodiments, the edible microbial oil comprises 0-15% diacylglycerol content.

In some embodiments, the edible microbial oil has a similar triacylglycerol profile to plant-derived palm oil. Some plant-derived palm oils have over 80% C50 and C52 triacylgylcerols. In some embodiments, the edible microbial oil has a triacylglycerol profile comprising at least 40% C50 and C52 triacylglycerols.

In some embodiments, the edible microbial oil has a triglyceride profile wherein greater than 40% of the triglycerides have one unsaturated sidechain, and wherein greater than 30% of the triglycerides have two unsaturated sidechains.

In some embodiments, the present disclosure relates to food products comprising an edible microbial oil and/or derivative thereof. In some embodiments, the food product comprises between 0.1 and 30% edible microbial oil and/or derivatives thereof. In some embodiments, the food product is a nut butter or spread. In some embodiments, the food product is chocolate or a chocolate countline product. In some embodiments, the food product is a baked good. In some embodiments, the baked good is cookies or bread. In some embodiments, the food product is frozen or fresh pizza dough. In some embodiments, the food product is instant noodles. In some embodiments, the food product is ice cream. In some embodiments, the food product if frosting. In some embodiments, the food product is chips.

### Characteristics Similar to Meat and Dairy Fats

In some embodiments, the edible microbial oil and/or derivative thereof has similarities with meat fat. In some embodiments, the edible microbial oil and/or derivative thereof is a meat fat substitute in a food product. In some embodiments, the meat fat substitute further comprises at least one of an edible gum, a starch, and a gelling agent. In some embodiments, the food product is a meat substitute. In some embodiments, the meat substitute is a ground-beef like product. In some embodiments, the meat substitute or ground-beef like product does not comprise animal fat. In some embodiments, the meat substitute or ground-beef product does not comprise palm oil or palm kernel oil.

Examples of edible gums include, but are not limited to, curdian, locust bean gum, carrageenan, gellan gum, xanthan gum, guar gum, gelatin, sodium alginate, or combinations thereof. Examples of starch include, but are not limited to, potato starch, corn starch, rice flour, pea flour, modified starch, and combinations thereof. Examples of gelling agents include, but are not limited to, pectin, alginate, vegetable gums, gelatin, agar, methyl cellulose, and hydoroxypropylmethyl cellulose.

In some embodiments, the edible microbial oil and/or derivative thereof has similarities with dairy fat. In some embodiments, the edible microbial oil and/or derivative thereof is a dairy fat substitute in a food product. In some embodiments, the food product is a cheese-like substance. In some embodiments, the food product is a milk-like product. In some embodiments, the food product is an infant formula. In some embodiments, the cheese-like substance, milk-like product, or infant formula does not comprise palm oil or palm kernel oil. In some embodiments, the cheese-like substance, milk-like product, or infant formula product does not comprise animal fat.

In some embodiments, the edible microbial oils of the present disclosure have differences from plant-derived oils, meat fats, and dairy fats. In some embodiments, these differences are useful and allow for manipulation of the microbial oil for the improved production of a given product compared to plant-derived oil, meat fat, and dairy fat. For example, in some embodiments, the fatty acid profile of a microbial oil is tailored so as to produce a higher fraction of one or more fatty acids of interest for use in production of a food product. In some embodiments, other parameters of the microbial oil are also able to be manipulated for increased production of a component of interest or decreased production of an undesired component.

### Blended Fat Compositions

In some embodiments, the present disclosure relates to a blended fat composition, wherein the composition comprises a vegetable oil lipid source and at least 1% edible microbial oil and/or derivatives thereof.

In some embodiments, the vegetable oil lipid source is soybean oil, corn oil, rapeseed oil, canola oil, sunflower oil, safflower oil, coconut oil, rice bran oil, olive oil, sesame oil, flaxseed oil, hemp oil, or cottonseed oil. In some embodiments vegetable oil lipid is peanut oil, almond oil, beech nut oil, brazil nut oil, cashew oil, hazelnut oil, macadamia oil, mongongo nut oil, pecan oil, pine nut oil, pistachio oil, walnut oil, or pumpkin seed oil. In some embodiments, the vegetable oil lipid is grapefruit seed oil, lemon oil, apricot oil, apple seed oil, argan oil, avocado oil, or orange oil. In some embodiments, the blended fat composition does not comprise palm oil or palm kernel oil.

In some embodiments, the blended fat composition is a cooking oil, frying oil, shortening, margarine, or butter-like product. In some embodiments, the blended fat composition does not comprise palm oil or palm kernel oil. In some embodiments, the blended fat composition is a palm oil substitute. In some embodiments, the blended fat composition has one or more characteristics similar to plant-derived palm oil selected from the group consisting of: apparent density, refractive index, oxidative stability, saponification value, unsaponifiable matter, iodine value, slip melting point, fatty acid composition, triglyceride content, overall saturation level, and level of mono- and poly-unsaturated fatty acids.

### Method of Producing Food Products Comprising Microbial Oil and Processing of Microbial Oil

In some embodiments, the present disclosure teaches methods for producing a food product, comprising providing a microbial oil, and/or a derivative thereof, wherein the oil is produced from an oleaginous yeast; using the microbial oil and/or derivative thereof as an ingredient in a food product; and producing a food product. In some embodiments, the method further comprises processing the microbial oil, wherein the processing comprises physical refining, chemical refining, deodorizing, bleaching, and combinations thereof.

In some embodiments, the microbial oil is refined. In some embodiments, prior to refinement, the microbial oil is referred to as crude microbial oil. In some embodiments, the refinement process comprises the removal of one or more non-triacylglycerol components. Typical non-triacylglycerol components removed or reduced via oil refinement include free fatty acids, partial acylglycerols, phosphatides, metallic compounds, pigments, oxidation products, glycolipids, hydrocarbons, sterols, tocopherols, waxes, and phosphorous. In some embodiments, refinement removes certain minor components of the crude microbial oil with the least possible damage to the oil fraction (e.g., trans fatty acids, polymeric and oxidized triacylglycerols, etc.) and minimal losses of desirable constituents (e.g., tocopherols, tocotrienols, sterols, etc.). In some embodiments, processing parameters are adapted for retention of desirable minor components like tocopherols and tocotrienols and minimal production of unwanted trans fatty acids. See Gibon (2012) “Palm Oil and Palm Kernel Oil Refining and Fractionation Technology,” incorporated by reference herein in its entirety, for additional details of oil processing that are useful for the present microbial oils.

Common processing methods include physical refining, chemical refining, or a combination. In some embodiments, chemical refining comprises one or more of the following steps: degumming, neutralization, bleaching, dewaxing, and deodorization. In some embodiments, physical refining comprises one or more of the following steps: degumming, bleaching, dewaxing, and steam-refining deodorization. While “physical refining” and “chemical refining,” as used herein and in the art, may refer to a general process of oil purification comprising multiple steps, possibly including bleaching and/or deodorizing, in the context of the present disclosure, the term “refined” as it relates to a microbial oil, e.g., a refined microbial oil, refers to a microbial oil from which one or more impurities or constituents have been removed other than odor and pigment. As such, stating that a microbial oil is refined does not indicate that the microbial oil has been deodorized and/or bleached. The term “RBD,” as used herein and as applied to a microbial oil, indicates that the microbial oil has been each of refined, bleached, and/or deodorized.

In some embodiments, in chemical refining, the free fatty acids and most of the phosphatides are removed during alkali neutralization. In some embodiments, the non-hydratable phosphatides are first activated with acid and further washed out together with the free fatty acids during alkali neutralization with caustic soda. In some embodiments, chemical refining comprises one or more steps of acid treatment, centrifugation, bleaching, deodorizing, and the like.

In some embodiments, during physical refining, phosphatides are removed by a specific degumming process and the free fatty acids are distilled during the steam refining/deodorization process. In some embodiments, the degumming process is dry degumming or wet acid degumming. In some embodiments, physical refining is employed when the acidity of the crude microbial oil is sufficiently high. In some embodiments, physical refining is employed for crude microbial oil with high initial free fatty acid (FFA) content and relatively low phosphatides.

In some embodiments, the microbial oil is deodorized. In some embodiments, the deodorization process comprises steam refining. In some embodiments, deodorization comprises vacuum steam stripping at elevated temperature during which free fatty acids and volatile odoriferous components are removed to obtain bland and odorless oil. Optimal deodorization parameters (temperature, vacuum, and amount of stripping gas) are determined by the type of oil and the selected refining process (chemical or physical refining) but also by the deodorizer design.

In some embodiments, the microbial oil is bleached. In some embodiments, the bleaching is performed through the use of bleaching earth, e.g., bleaching clays. In some embodiments, the bleaching method employed is the two stage co-current process, the counter-current process, or the Oehmi process. In some embodiments, the bleaching method is dry bleaching or wet bleaching. In some embodiments, bleaching is accomplished through heat bleaching. In some embodiments, bleaching and deodorizing occur concurrently.

In some embodiments, the microbial oil is refined, bleached, and/or deodorized.

In some embodiments, the microbial oil is not bleached or is only partially bleached. For example, in some embodiments, the microbial oil still retains pigments after processing. In some embodiments, the microbial oil comprises any one or more of the pigments referenced herein. Therefore, in some embodiments, the microbial oil is refined and deodorized, but not bleached or not fully bleached.

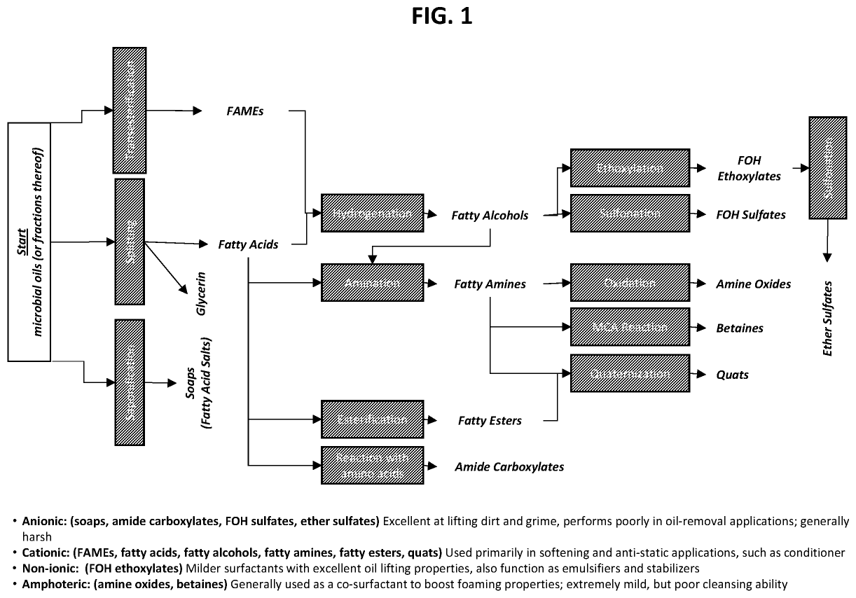

As shown in FIG. 1, the edible microbial oil may be processed or modified by a number of means to generate derivatives for use in food products. For example, as shown in FIG. 1, the edible microbial oil or fractions thereof may be modified by transesterification to produce FAMEs, or split (hydrolysis) to produce fatty acids and glycerin. These FAMEs and fatty acids may be subsequently hydrogenated to produce fatty alcohols. The fatty alcohols may undergo ethoxylation and/or sulfonation to produce fatty alcohol ethoxylates, fatty alcohol sulfates, or ether sulfates. The fatty acids may also be modified by amination, esterification, and reactions with amino acids to produce fatty amines, fatty esters, and amide carboxylates respectively. Fatty amines may further be modified by oxidation, monochloracetic acid (MCA) reaction, and quaternization to produce amine oxides, betaines, and quats respectively. The edible microbial oil or fraction thereof may also be modified by saponification to produce fatty acid salts. Any of these derivatives and intermediate products may be used in food products. Thus, in some embodiments, the edible microbial oil is processed and/or modified via one or more of fractionation, hydrogenation, hydrolysis, distillation, saponification, esterification, interesterification, transesterification, amination, ethoxylation, sulfonation, oxidation, quaternization, MCA reaction, and/or reaction with amino acids.

Fractionation

Fractionation of is another means of processing the microbial oil described herein for consumption and use in food products. Fractionation may be used to physically separate room temperature oil into saturated and unsaturated components. The melting points of full oil mixtures and their saturated/unsaturated components differ. Hydrophilization makes use of surface active agents (surfactants) that dissolve solidified fatty crystals and emulsify liquid oils. By centrifuging this hydrophilized suspension, fats can be separated into different fractions based on saturation.

In some embodiments, the edible microbial oil is fractionable. In some embodiments, the edible microbial oil is fractionable into two or more fractions. In some embodiments, the edible microbial oil is fractionable into more than two fractions. In some embodiments, the edible microbial oil is fractionable into two fractions, which may then be further fractionated.

In some embodiments, the edible microbial oil is fractionable into two fractions. In some embodiments, the two fractions are microbial olein and microbial stearin. In some embodiments, the microbial olein is a substitute for palm olein. In some embodiments, the microbial stearin is a substitute for palm stearin. In some embodiments, each fraction comprises at least 10% of the edible microbial oil's original mass. In some embodiments, the iodine value (IV) of the fractions differs by at least 10. In some embodiments, the iodine value of the fractions differs by at least 20. In some embodiments, the iodine value of the fractions differs by at least 30.

In some embodiments, the edible microbial oil is fractionated. In some embodiments, fractionation is carried out in multiple stages, resulting in fractions appropriate for different downstream indications. In some embodiments, the edible microbial oil is fractionated via dry fractionation. In some embodiments, the edible microbial oil is fractionated via wet fractionation. In some embodiments, the edible microbial oil is fractionated via solvent/detergent fractionation.

Hydrolysis

Hydrolysis is the process whereby triglycerides in fats and oils are split (“fat splitting” or “oil splitting”) into glycerol and fatty acids. It is usually carried out using great amounts of high-pressure steam (“steam hydrolysis”) but may also be performed using catalysts (for example, the tungstated zirconia and solid acid composite SAC-13 (Hydrolysis of Triglycerides Using Solid Acid Catalysts, Ngaosuwan, K, et al., Ind. Eng. Chem. Res., 2009 48 (10), 4757-4767)). The reaction proceeds in a step-wise fashion wherein fatty acids on triglycerides are displaced one at time, generating diglycerides, then monoglycerides, and finally free fatty acids and glycerin.

In some embodiments, the edible microbial oil is split into free fatty acids and glycerol. In some embodiments, the edible microbial oil is split by steam hydrolysis. In some embodiments, the free fatty acids are further purified and/or separated into fractions through distillation or fractionation. In some embodiments, the resulting diglycerides, monoglycerides, free fatty acids, and glycerol are used in food products.

Linear free fatty acids are often used as a food additive as a lubricant, binder, and defoaming agent. Food-grade fatty acids include, for example, caprylic acid (C8), capric acid (C10), lauric acid (C12), myristic acid (C14), palmitic acid (C16), stearic acid (C18), and oleic acid (C18). Thus, in some embodiments, the microbially-derived free fatty acids may be used as a food additive and replace palm-oil derived free fatty acids.

Glycerol, also called glycerin, is a sweet syrupy liquid that is a safe food additive. It is used in a variety of food products as a thickener, stabilizer, and moisture control agent, and is often labeled as a sugar alcohol on the ingredients list. Some example food items that may contain glycerin include, but are not limited to, beverages, nutrition and energy bars, cake icing/frosting, candy, chewing gum, condiments and sauces (such as mustard, vinegar, sweeteners, butter, nut butters), diet foods, dried fruits, fondant, fudge, marshmallows, dairy foods, processed meat and poultry, canned vegetables and canned fruit, pudding, bread, and pre-cooked rice. Thus, microbially-derived glycerin may replace glycerin derived from palm oil in any of the example foods listed above.

Distillation

Distillation is a process whereby fatty acids and impurities are separated based on differences in boiling points. Fatty acids have a lower boiling point than impurities, such that the fatty acids may be vaporized, condensed, and collected, and the high-boiling impurities are left behind. In some embodiments, the present disclosure relates to food products comprising distilled fatty acids derived from an oleaginous yeast.

Hydrogenation

Hydrogenation is the process whereby liquid fats are made solid or partially solid by adding hydrogen. The extra hydrogen converts the double bonds in unsaturated fats to single bonds, generating saturated fats. Unless the process is controlled, some fats may be partially hydrogenated and this leads to “trans fats”, so named due to the trans configuration of the molecule. In the U.S., artificial trans fats have been banned from food products, however some of these fats still occur naturally. Ingesting trans fats, or “hydrogenated oil” or “partially hydrogenated oil” has been shown to increase low-density lipoprotein, the so called “bad cholesterol”. However, these fats are more stable, and increase the shelf life of food. They also create consistencies that consumers prefer, for example, peanut butter that is smooth and creamy, and the spreadability of margarine. Hydrogenated oils also prevent the rancid odors caused by oxidation, thus increasing the shelf life of the product, and may also provide a thicker consistency.

The FAMEs produced by transesterification may be hydrogenated to produce fatty alcohols. Fatty acids produced from hydrolysis may also be further modified via esterification to produce wax esters, which may then be hydrogenated to produce fatty alcohols. Direct hydrogenation of fatty acids is also possible and produces fatty alcohols. Thus, in some embodiments, the oil is derivatized to fatty alcohols. In some embodiments, fatty alcohols derived from an oleaginous yeast are used in a food product. In some embodiments, the fatty alcohols are further refined and/or distilled. In some embodiments, the microbially-derived fatty alcohol is selected from the group consisting of palmityl alcohol, cetearyl alcohol, cetostearyl alcohol, stearyl alcohol, cetyl alcohol, isocetyl alcohol, isostearyl alcohol, myristyl alcohol, octyl decyl alcohol, octyl alcohol, decyl alcohol. In some embodiments, the microbially-derived fatty alcohol is a substitute for fatty alcohols derived from vegetable oil.

In some embodiments, the fatty alcohols are further derivatized by ethoxylation and/or sulfonation. In some embodiments, the fatty alcohol derivative is a fatty alcohol ethoxylate or alkoxylate. In some embodiments, the fatty alcohol derivative is a fatty alcohol sulfate.

Steareths may also be derived from the microbial oil described herein and used in food products, generally as an additive. Steareths are produced by ethoxylation of stearyl alcohol (prepared from stearic acid from an oleaginous microorganism). Examples of steareths include steareth-2, steareth-7, steareth-10, steareth-11, steareth-13, steareth-14, steareth-15, steareth-16, steareth-20, steareth-21, steareth-25, steareth-27, steareth-30, steareth-40, steareth-50, steareth-100.

Saponification

Saponification is the process whereby triglycerides or free fatty acids used as feedstock are converted to fatty acids salts, glycerol, and free fatty acids in the presence of a base. The base may be for example, sodium hydroxide or potassium hydroxide. Saponification may be achieved via a hot or cold process. The cold process uses the heat generated from the combination of the fatty acids in the melted oils and fats with a base. The hot process uses heat to speed up the saponification process. The most commonly used oil sources are vegetable oils, specifically palm and coconut oils, which contain shorter saturated fatty acids.

In some embodiments, the edible microbial oil, free fatty acids, and/or triglycerides are used as feedstock in a saponification reaction to produce fatty acid salts, glycerol, and/or free fatty acids. In some embodiments, these fatty acid salts, glycerol, and/or free fatty acids are used in a food product. In some embodiments, the fatty acid salt is selected from the group consisting of an aluminum salt, a sodium salt, a potassium salt, a calcium salt, or a magnesium salt. In some embodiments, the fatty acid salt is sodium palmate or sodium stearate. In some embodiments, the fatty acid salt is magnesium stearate. In some embodiments, the magnesium stearate is used as an emulsifier, binder, thickener, anticaking, lubricant, release, and/or antifoaming agent in a food product. In some embodiments, the food product is a supplement, spice, confectionery, chewing gum, or baking ingredient.

Esterification

Esterification is the general name for a reaction that generates esters, a compound derived from an acid. Esterification of fatty acids can generate nonionic surfactants (see for example, Li X., et al., Fatty acid ester surfactants derived from raffinose: Synthesis, characterization and structure-property profiles, 2019, J. of Colloid and Interface Science, Vol. 556(15); 616-627). For example, glycerol esters can be used as emulsifiers, dispersants, and solubilizing agents.

Many esters have fruit-like odors and occur naturally in essential oils of plants, and may be used in fragrances to mimic those odors. In some embodiments, the edible microbial oil is derivatized to esters. In another embodiment, esters derived from an oleaginous yeast are used in a food product.

In some embodiments, the edible microbial oil is modified via interesterification. In some embodiments, the interesterification is enzymatic. In some embodiments, the interesterification is chemical. In some embodiments, the edible microbial oil is modified via transesterification. In some embodiments, the oil is derivatized to fatty acid methyl esters (FAMEs). In some embodiments, the methyl esters are used in food products. For example, microbially-derived methyl esters may be used as a substitute for fractionated palm methyl esters in food products. In some embodiments, the microbially-derived ester is glycerol monostearate. In some embodiments, the microbially-derived ester is palmitate or ethyl palmitate.

In some embodiments, the present disclosure relates to food products comprising a microbially-derived ester, wherein the ester is a sorbitan ester and/or polysorbate. In some embodiments, the polysorbate is selected from the group consisting of polysorbate-40, polysorbate-60, polysorbate-65, polysorbate-80, and polysorbate-85. In some embodiments, the sorbitan ester is selected from the group consisting of sorbitan monostearate, sorbitan tristearate, and sorbitan monoolate. In some embodiments, the sorbitan ester and/or polysorbate is used as an emulsifier in whipped topping, ice cream, icings, chocolate, pudding mixes, or shortening.

### Surfactants

An embodiment of the present disclosure relates to food products comprising microbial oil derivative, wherein the derivative functions as a surfactant in the food product.

Surfactants are a broad category of compounds that lower the surface tension between two liquids, for example oil and water, between a gas and a liquid, or between a liquid and a solid. They can be classified by their head group as either non-ionic (neutral), anionic (negatively charged), cationic (positively charged), or amphoteric (both positive and negative charges). In food products they may be used in emulsions, suspensions, and gels, for example, in condiments such as mayonnaise, margarine, and salad dressings, and deserts.

### Tailored Fatty Acid Profile

As discussed above, in some embodiments, the fatty acid profile of a microbial oil is tailored so as to produce a higher fraction of one or more fatty acids of interest for use in production of a food product. In some embodiments, other parameters of the microbial oil are also able to be manipulated for increased production of a component of interest or decreased production of an undesired component. As will be understood by one skilled in the art, the microorganisms described herein may be tailored to produce more less of a particular lipid, for example, C8 (caprylic acid), C10 (capric acid), and C12 (lauric acid). Thus, these fatty acids as well as others, and their derivatives are within the scope of the present disclosure.

The present description is made with reference to the accompanying drawings and Examples, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive “or” in the manner of “and/or.”

Those skilled in the art will recognize that, in some embodiments, some of the operations described herein may be performed by human implementation, or through a combination of automated and manual means. When an operation is not fully automated, appropriate components of embodiments of the disclosure may, for example, receive the results of human performance of the operations rather than generate results through its own operational capabilities.

### EXAMPLES

### Example 1: Rhodosporidium Toruloides Fermentation on Industrial Fermentation Waste Stream Feedstock

Exemplary feedstocks of corn stillage syrup, corn thin stillage, corn whole stillage, and corn stillage pre-blend were used in the fermentation of an exemplary oleaginous yeast, Rhodosporidium toruloides.

### Feedstock Preparation

Corn stillage syrup has a high viscosity and requires centrifugation and/or dilution prior to use as a feedstock. Five preparations of the feedstock were made. Preparation A comprised a 10% v/v dilution of the feedstock with water (10% syrup, 90% water), spun down at 5000 g for 10 min to remove insoluble components. Preparation B comprised the feedstock spun down at 5000 g for 10 min to remove insoluble components without dilution. Preparation C comprised a 10% dilution of the feedstock with water (10% syrup, 90% water). Preparation D comprised a 20% dilution of the feedstock with water (20% syrup, 80% water). Preparation E comprised a 30% dilution of the feedstock with water (30% syrup, 70% water). These preparations were compared to a theoretically optimized medium comprising a C/N ratio of 100 (control preparation).

Culturing R. toruloides

100 mL of each preparation was autoclaved in a 250 mL flask and inoculated to OD600=1 with precultures of R. toruloides cultivated overnight in YPS (10 g/L yeast extract, 20 g/L peptone, g/L sucrose). The cultures were shaken at 200 rpm, 30° C. for 6 to 9 days, and the cells were harvested by centrifugation.

### Determination of Biomass and Lipid Content

The harvested cells were dried in a vacuum oven at 60° C. until their mass was stable. The cells were weighed and lipids were subsequently extracted by acid lysis followed by chloroform:methanol separation. In short, 400 mg of powdered biomass were mixed with 3.2 mL of 4 M hydrochloric acid and incubated at 55° C. for 2 h. 8 mL of chloroform:methanol 1:1 were added. The solution was shaken vigorously for 3 h and centrifuged at 6000 g for 15 min. The chloroform layer was separated and 4 mL of pure chloroform were added. The solution was shaken vigorously for 30 min, spun down again, and the chloroform layer was separated. The samples in chloroform were dried under nitrogen stream until mass was constant and mass was recorded.

Corrections were applied to the measured lipid titers in order to account for lipids already present in the feedstock preparations. Lipids from the “blank” preparations were extracted as described above for the cultures, and the amount of lipids in the blank was subtracted from the amount of lipids in the cultures in order to get the actual amount of lipids produced by R. toruloides. This process provides a low conservative estimate of the lipids produced by the microorganisms, as the yeast consume some portion of the lipids present in the feedstock. For Preparation A and Preparation B, the lipids were separated via centrifugation of the broth prior to inoculation, so no correction was applied.

### Results

Various preparations of the feedstock were able to support oleaginous microbial growth and lipid production. The feedstock contains high concentrations of glycerol, making it viscous and decreasing oxygen transfer. As such, because of the high viscosity of the feedstock, it is impractical for use as is in a shaken vessel, which is why preparation B produced lower biomass production than the other preparations. However, dilutions of the feedstock and clarification by centrifugation (removal of solids) allow for good biomass and lipid production. Increased concentrations of feedstock lead to increasing biomass production and lipid titer (preparations C, D, and E), until viscosity limits oxygen and nutrient transfer (preparation B). Preparation E performed as well as the optimized control preparation. Further, it was shown that lipid content can be optimized by adjusting the time period of fermentation.

### Example 2: Media Formulation, Fermentation, and Lipid Extraction

### Media Formulation

For the following examples, fermentation feedstocks were acquired in 4 separate formulations—i.e., as whole stillage, thin stillage, clarified stillage, and syrup. Fermentation media formulations were optionally diluted in deionized water at various fractions (a “10% feedstock” medium indicates a 1:9 ratio of feedstock fraction to water). Feedstocks were optionally fractionated into supernatant and solid fractions via centrifugation.

### Fermentation

To prepare inocula, yeast strains were propagated at 30° C., 200 rpm, for 28 hours in yeast extract-peptone-dextrose (YPD) medium composed of 10 g/L yeast extract, 20 g/L peptone, and 20 g/L dextrose. Cultures were washed of residual nutrients before inoculating 100 mL of the exemplary feedstock to a starting OD600 of 1.0.

Fermentations were run in 250 mL baffled flasks within an orbital shaker incubator at 200 rpm and 30° C. During harvest, cultures were centrifuged at 4700 g for 10 minutes to pellet, resuspended in 20 mL deionized water, and centrifuged again to yield a washed, wet cell pellet.

### Insoluble Matter Correction and Solvent Pre-Wash Procedure Before Lipid Extraction

Some exemplary feedstocks formulated from post-fermentation waste streams contain insoluble matter that needs to be removed or quantified to result in accurate microbial biomass and lipid content calculations. To correct for this content within the feedstock itself, blank cultures were prepared and collected to assess the carryover weight of insoluble matter in the exemplary feedstock. For feedstocks formulated from corn thin stillage, the biomass was able to be separated from the insoluble matter, such that no correction was required. For feedstocks formulated from post-fermentation media clarified supernatants after centrifugation, the feedstock did not comprise insoluble matter, and no correction was necessary.

For all feedstock formulations, the extraction of native lipids was performed on the wet cell pellet/feedstock mixture using a solvent pre-wash of 20 mL chloroform/methanol mixture (2:1 v/v). The pellet and pre-wash mixture was then incubated in a 50° C. water bath for 10 minutes. Next, it was incubated in a 50° C. shaker at 400 rpm for 45 minutes. Samples were centrifuged at 4700 g for 10 minutes to induce phase separation. Chloroform and methanol were carefully decanted. The insoluble matter of the diluted corn stillage syrup feedstock could not be separated from the biomass to obtain a pure wet cell pellet, but the biomass could be separated from the thin stillage insoluble matter using 250 g/L sorbitol for a density gradient. Collected and washed cultures were resuspended in 45 mL 250 g/L sorbitol then centrifuged at 4700×g for 10 minutes. The top layer that formed was the desired biomass, whereas the insoluble matter collected at the bottom. The biomass layer was isolated and washed in 45 mL deionized water to obtain the wet cell pellet.

### Lipid Extraction

Biomass was dried to a constant mass in a vacuum oven. Dry cell weight (DCW) was then measured, with correction for insoluble matter as needed. Dried biomass was lysed with 8 mL 4M HCl at 55° C., mild agitation for two hours and extracted with 8 mL chloroform/methanol mixture (2:1 v/v) at room temperature, 350 rpm for three hours. The mixture was centrifuged at 4700 g for 10 minutes. The lower layer of chloroform with extracted lipids was isolated and re-extracted using 4 mL chloroform at room temperature, 350 rpm for 30 minutes. Chloroform was evaporated to finalize the lipid extraction. Oil titer was then calculated, with correction for contributions from insoluble matter as needed. Lipid content was determined by dividing oil titer by dry cell weight.

### Example 3: Fermentation of Oleaginous Microorganisms on Exemplary Feedstock

### Feedstock

For the purposes of this example, the exemplary feedstock employed was a 30% corn stillage syrup-based feedstock, comprising 30% v/v corn stillage syrup, with insoluble components removed via centrifugation, diluted in deionized water.

### Microorganisms

Four strains of oleaginous microorganisms were selected to investigate the potential of the exemplary feedstock to support the growth of oleaginous microorganisms: R. toruloides strain A, R. toruloides strain B, Y. lipolytica strain polg, and L. starkeyi strain CBS 1807. As a control, a canonical non-oleaginous yeast, P. pastoris strain X33, was included for comparison.

### Batch Fermentation Results

Fermentations were run in batch format for 6 days. Dry cell weight, oil titer and lipid content were evaluated as described in Example 5.

The feedstock supported cell growth for all of the tested yeast strains. The two strains of R. toruloides performed the best in terms of oil titer and lipid content.

Batch Fermentation Results with Glycerol Supplement

50 g/L glycerol was added to the feedstock and fermentations were again run for 6 days. Dry cell weight and oil titer were evaluated and compared to the results of the batch fermentation. Surprisingly, both strains of R. toruloides dramatically increased growth and oil production with added glycerol, while Y. lipolytica and L. starkeyi experienced significantly less growth and only marginally improved oil titer.

### Example 4: Fed Batch Fermentation with R. toruloides

A strain of R. toruloides was tested in a fed-batch fermentation format on two different exemplary feedstocks of the disclosure: 30% stillage and 40% stillage. The 30% and 40% stillage feedstocks were formulated with 30% and 40% corn stillage syrup, respectively, diluted in deionized water. The strain was also grown on defined media as a control. The carbon source for this fed batch fermentation was pure glycerol. The cultures were periodically sampled to measure residual glycerol concentration (via HPLC) and then fed with a bolus of concentrated glycerol (800 g/L) to replenish carbon to 60 g/L.

The fermentations were run for 7 days (˜148 hrs). Total target glycerol (batch+feed) was 281.5 g/L. The cells were then evaluated for DCW, oil titer, lipid content, productivity, and yield. Productivity was calculated by taking the oil titer and dividing by the fermentation time in hours. Yield was calculated by taking the oil titer and dividing by the mass of total glycerol (batch and feed) per liter.

### Results

The 40% feedstock outperformed the 30% feedstock which outperformed the defined media control in terms of DCW, oil titer, productivity, and yield. Lipid content, which is calculated by dividing the oil titer by the DCW, was comparable across all three feedstocks.

These results demonstrate that the feedstocks of the present disclosure can be used to produce high oil titers, over 30 g/L for the 40% feedstock condition, in the commercially relevant setting of fed batch fermentation.

### Example 5: Exemplary R. toruloides Growth on Different Feedstocks and Carbon Sources

### Growth on Different Post-Fermentation Feedstocks

Two exemplary R. toruloides strains, strain A and strain B, were fermented on three exemplary post-fermentation feedstocks of the present disclosure. The feedstocks were: 30% thin stillage—30% thin corn stillage diluted in deionized water; 100% whole stillage; and 30% clarified thin stillage—30% thin corn stillage diluted in deionized water and then clarified via centrifugation. The DCW results demonstrated that all three of these feedstocks were able to support cell growth for both strains of R. toruloides.

### Growth on Different Carbon Sources

Three exemplary strains of R. toruloides (strains A, B, and C) were grown on yeast peptone (YP) media (20 g/L peptone, 10 g/L yeast extract) with added arabinose, glucose, glycerol, sucrose, and xylose combined to determine the ability and preference of this species to consume different carbon sources. The carbon sources were added to equal initial concentrations of 12 g/L each, with a total carbon content of 60 g/L within the sample. The consumption of these carbon sources was measured via HPLC over time. The results of the analysis demonstrated that all three tested strains of R. toruloides could use any of the five carbon sources as fuel. All five carbon sources were consumed by R. toruloides strain A, with the general trend of preference in terms of consumption being: Glucose>Sucrose>Xylose/Fructose>Glycerol>Arabinose. These results indicate that three different exemplary strains of R. toruloides were able to utilize a variety of carbon sources as fuel for fermentation.

### Example 6: Comprehensive Analysis of an Illustrative Crude Microbial Oil Sample

A 100 g sample of crude microbial oil produced by the oleaginous microorganism R. toruloides was analyzed for general physical chemical characterization; fatty acid content, triglyceride content, diglyceride content, monoglyceride content, slip melting point, color; and contaminant (3-MCPD, GEs) levels. These analyses were carried out in comparison to standard Colombian palm oil and hybrid palm oil samples over the course of 70 days. Samples were stored in the dark, at cold temperatures, and at atmospheric nitrogen conditions.

The three oil samples were analyzed along different physical and chemical parameters, the results of which analyses are shown in Table 4. The methods employed were those of the American Oil Chemists' Society (AOCS) and are referenced within the Table by their AOCS identifier.

TABLE 3
General physical chemical characterization

| | | | | Crude | Crude | Crude |
|---|---|---|---|---|---|---|
| | | | | microbial | palm | hybrid |
| Parameter | Unit | Method | Equipment | oil | oil | palm oil |
| Free fatty acid | % | AOCS Ca | 865Dosimat plus | 2.58 | 2.81 | 2.02 |
| content | | 5a-40 | (Metrohm) | | | |
| Triglyceride | % | Arithmetical | — | 96.5 | 96.3 | 93.6 |
| content | | calculation | | | | |
| Diglyceride | % | AOCS Cd | GC-COC/FID | 0.94 | 5.49 | 4.04 |
| content | | 11b-91 | (7890A, Agilent) | | | |
| Monoglyceride | % | AOCS Cd | GC-COC/FID | <0.1 | <0.1 | <0.1 |
| content | | 11b-91 | (7890A, Agilent) | | | |
| Slip melting | ° C. | AOCS Cc | Magnetic Stirrer | >15 | 36.2 | >15 |
| point | | 3-25 | (MR-Hei-Std, | | | |
| | | | Heidolph) | | | |
| Color | red | AOCS Cc 13e- | Spectrocolorimeter | 46 | 28.4 | 39 |
| (Lovibond). | | 92 (cuvette 1″) | PFXi Series 995 | | | |
| Day 0. | | | (Lovibond) | | | |
| | yellow | | | 70 | 47 | 70 |

As shown in Table 3 above, crude microbial oil has similar amounts of free fatty acids, triglycerides, and monoglyceride as those found in crude palm oil and crude hybrid oil. Specific triglycerides were also measured and shown below.

Levels of contaminants were assessed in microbial oil, crude palm oil, and crude hybrid palm oil, with results shown in Table 4. The methods and equipment are shown in columns two and three, respectively.

TABLE 4
Contaminant levels

| | | | | | Crude |
|---|---|---|---|---|---|
| | | | Crude | Crude | hybrid |
| Contaminant | Method | Equipment | microbial oil | palm oil | palm oil |
| 3-MCPD | DGF C-VI | GC-SSL/MSD | <LOQ | <LOQ | <LOQ |
| | 18 (10) | (7890-5977A, | | | |
| | | Agilent) | | | |
| GEs | DGF C-VI | GC-SSL/MSD | <LOQ | <LOQ | <LOQ |
| | 18 (10) | (7890-5977A, | | | |
| | | Agilent) | | | |
| Phosphorus | AOCS Ca 12- | Spectrophotometer | <1 ppm | 25 ppm | 20 ppm |
| content | 55 | UV-1280 | | | |
| | | (Shimadzu) | | | |

All three samples had contaminant levels below the limit of quantitation (LOQ). However, the samples differed greatly in the amount of phosphorous detected. Unlike crude palm oil and crude hybrid palm oil, which had 25 ppm and 20 ppm respectively, crude microbial oil had less than 1 ppm of phosphorous.

Edible microbial oil may be used in food products, for example as a replacement for any vegetable-derived oil, meat fat, or dairy fat.

### Example 7: Comprehensive Analysis of Triglyceride Composition

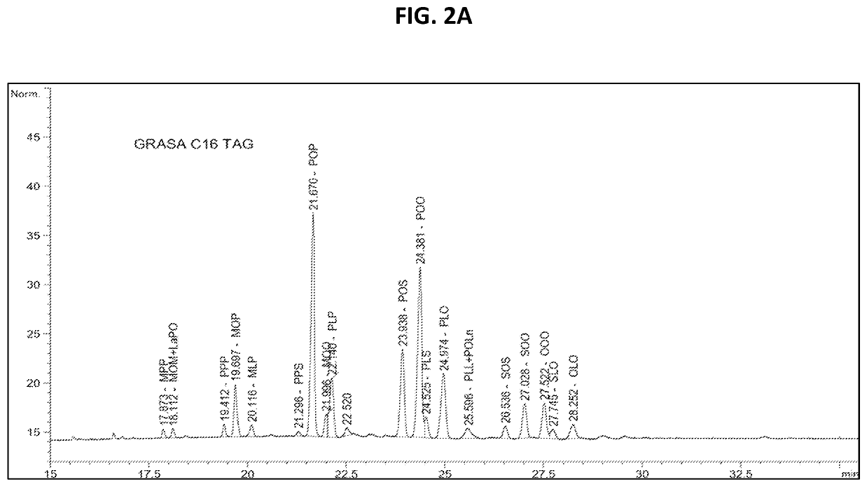

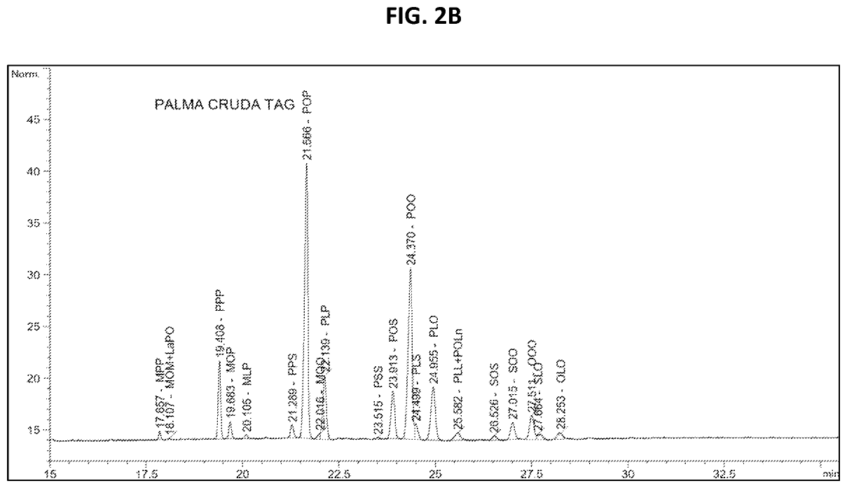

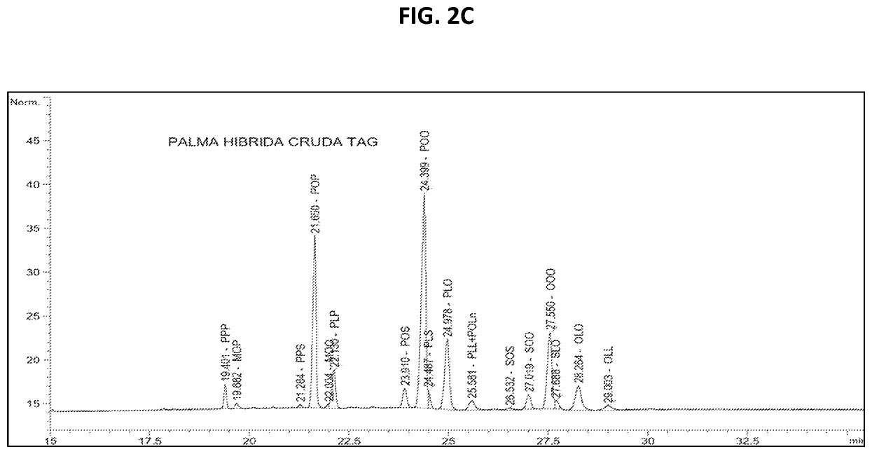

The triglyceride compositions of the three samples were analyzed on a GC-COC/FID (7890A, Agilent) instrument according to the AOCS Ce 5-86 method. Table 5 shows the results of the triglyceride analysis, with values as w/w percentages. The abbreviations used are as follows. M: Myristic fatty acid; S: Stearic fatty acid; P: Palmitic fatty acid; O: Oleic fatty acid; L: Linoleic fatty acid; La: Lauric fatty acid; Ln: linoleic fatty acid. The chromatogram for crude microbial oil is shown in FIG. 2A, the chromatogram for crude palm oil is shown in FIG. 2B, and the chromatogram for crude hybrid palm oil is shown in FIG. 2C.

TABLE 5
Triglyceride composition

| | | Crude | Crude | Crude |
|---|---|---|---|---|
| Triglyceride | Unit | microbial oil | palm oil | hybrid palm oil |
| MPP | % | 0.65 | 0.60 | 0.00 |
| MOM + LaPO | % | 0.75 | 0.12 | 0.00 |
| PPP | % | 1.02 | 6.48 | 2.11 |
| MOP | % | 4.73 | 1.58 | 0.55 |
| MLP | % | 1.27 | 0.35 | 0.00 |
| PPS | % | 0.43 | 1.38 | 0.35 |
| POP | % | 22.53 | 31.62 | 19.45 |
| MOO | % | 1.89 | 0.49 | 0.37 |
| PLP | % | 7.51 | 7.87 | 5.20 |
| PSS | % | 0.00 | 0.23 | 0.00 |
| POS | % | 10.25 | 6.11 | 2.68 |
| POO | % | 20.78 | 23.24 | 32.62 |
| PLS | % | 2.12 | 1.62 | 1.38 |
| PLO | % | 9.11 | 8.08 | 11.53 |
| PLL + POLn | % | 2.04 | 1.41 | 1.78 |
| SSS | % | 0.00 | 0.00 | 0.00 |
| SOS | % | 1.53 | 0.60 | 0.29 |
| SOO | % | 4.29 | 2.46 | 2.29 |
| OOO | % | 4.54 | 3.63 | 12.17 |
| SLO | % | 1.30 | 0.98 | 1.09 |
| OLO | % | 2.33 | 1.14 | 4.93 |
| OLL | % | 0.00 | 0.00 | 1.23 |
| LLL | % | 0.00 | 0.00 | 0.00 |
| LLnL | % | 0.00 | 0.00 | 0.00 |
| LnLLn | % | 0.00 | 0.00 | 0.00 |
| LnLnLn | % | 0.00 | 0.00 | 0.00 |
| OOA | % | 0.00 | 0.00 | 0.00 |
| LLnLn | % | 0.00 | 0.00 | 0.00 |
| SOA | % | 0.00 | 0.00 | 0.00 |
| Total | % | 99.06219 | 100 | 100 |

The microbial oil sample showed similarity to both palm oil and hybrid palm oil along different parameters of fatty acid and triglyceride content. For example, microbial oil comprised approximately 1.2% w/w palmitic-palmitic-palmitic triglycerides, approximately 22.53% w/w palmitic-palmitic-oleic triglycerides, approximately 20.78% w/w oleic-oleic-palmitic triglycerides, approximately 1.53% w/w stearic-stearic-oleic triglycerides, and approximately 4.29% w/w stearic-oleic-oleic triglycerides.

### Fatty Acids at Sn-2 Position

The three samples were analyzed for the amount of palmitic and stearic fatty acids located at the sn-2 position of triglyceride molecules, with results shown in Table 6. Methods used were adapted from Luddy et al., “Pancreatic lipase hydrolysis of triglycerides by a semimicro technique,” Journal of the American Oil Chemists' Society 1964; 41(10):693-6, and Pina-Rodriguez et al., “Enrichment of amaranth oil with ethyl palmitate at the sn-2 position by chemical and enzymatic synthesis,” Journal of Agricultural and Food Chemistry 2009; 57(11):4657-62, each incorporated herein by reference in its entirety.

TABLE 6
Fatty acids at sn-2 position of triglycerides

| | | Crude | Crude | Crude |
|---|---|---|---|---|
| | | microbial | palm | hybrid |
| Parameter | Equipment | oil | oil | palm oil |
| Palmitic acid (%) | TLC silica gel 60 | 12 | 14.4 | NA |
| at sn-2 position | F254 GC-SSL/FID | | | |
| | (7890A, Agilent) | | | |
| Stearic acid (%) | | 12 | 14.1 | NA |
| at sn-2 position | | | | |

The microbial oil sample contained an acceptable amount of palmitic and stearic fatty acids located at the sn-2 position of the triglyceride molecules, indicating the oil has suitability for use in various food products.

### Example 8: Fractionated Microbial Olein and Stearin Production

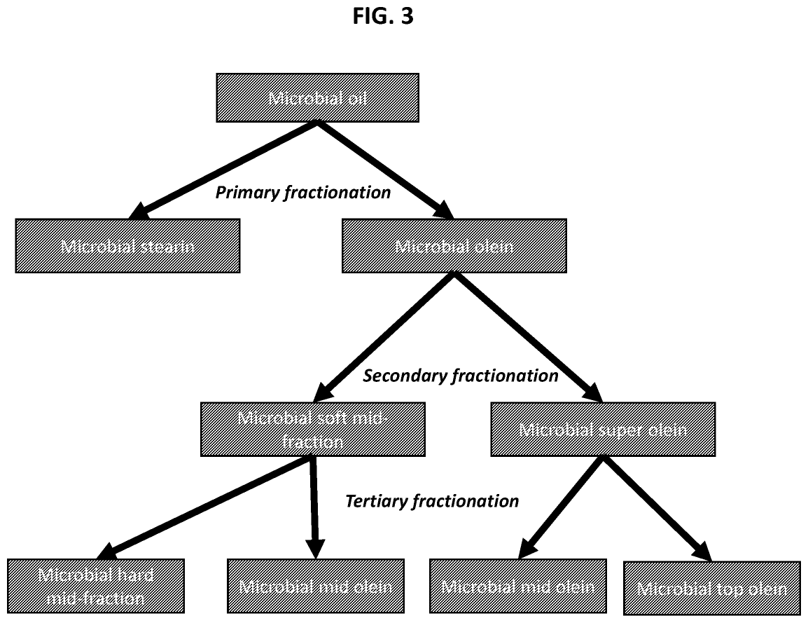

Fractionation of is another means of processing the microbial oil described herein for consumption and use in food products. Fractionation may be used to physically separate room temperature oil into saturated and unsaturated components. As shown in FIG. 3, the primary fraction of microbial oil results in microbial stearin and microbial olein. A secondary fraction of microbial olein results in microbial soft mid-fraction and microbial super olein. A tertiary fractionation of the soft mid-fraction results in a microbial hard mid-fraction and microbial mid-olein. A tertiary fractionation of the microbial super olein results in microbial mid-olein and microbial top olein.

The melting points of full oil mixtures and their saturated/unsaturated components differ. Hydrophilization makes use of surface active agents (surfactants) that dissolve solidified fatty crystals and emulsify liquid oils. By centrifuging this hydrophilized suspension, fats can be separated into different fractions based on saturation. Palm oil and microbial oil were fractionated and the saturation levels of their fractions were compared.

Crude palm oil and an R. toruloides microbial oil were fractionated using a method as set out in, e.g., Stein, W., “The Hydrophilization Process for the Separation of Fatty Materials,” Henkel and Cie, GmbH, Presented at AOCS Meeting, New Orleans, May 1967.

The oil sample was weighed and then incompletely melted to 50° C. The temperature was then brought down to 32° C. over the course of 10 min. The temperature was then slowly lowered to 20° C. with periods of time held at select temperatures between 32° C.-20° C. as follows: 32° C.-30 min; 26° C.-15 min; 24° C.-15 min; 22° C.-15 min; 21° C.-15 min; 20° C.-15 min. The oil sample was then maintained at 20° C. for an additional 1 hr.

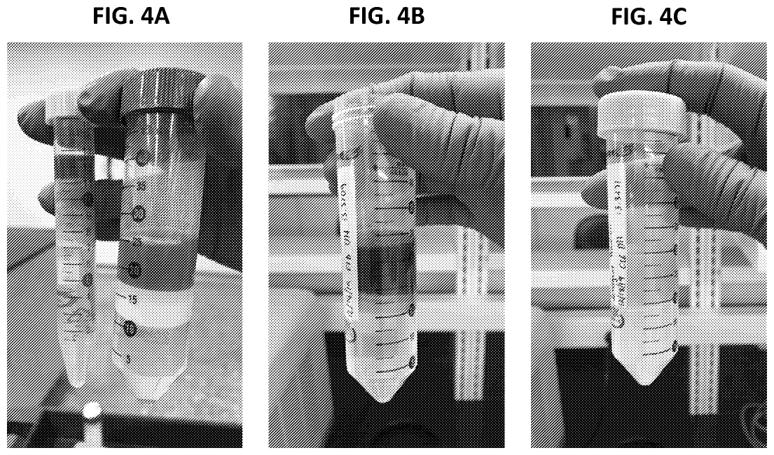

After this temperature manipulation, the oil sample was emulsified in a wetting agent solution at a ratio of 1:1.5 w/w fat to wetting agent. The wetting agent was comprised of a salt and a detergent in DI water: 0.3% (w/w) sodium lauryl sulfate; 4% (w/w) magnesium sulfate. The oil/wetting agent mixtures were vortexed until thoroughly mixed. The samples were centrifuged at 4700 rpm for 5 min in a benchtop centrifuge. The lighter oil phase migrated to the top, while the heavier aqueous phase (containing solid, saturated fatty particles) migrated to the bottom. Shown in FIG. 4A is a photograph of a fractionation of crude microbial oil (left) and crude palm oil (right). The top olein layer is liquid, and the bottom stearin layer is solid. FIG. 4B is a photograph of a complete fractionation of crude microbial oil, and FIG. 4C is a photograph of an incomplete fractionation of crude microbial oil.

The aqueous phase was separated by aspirating the upper olein phase into a pre-weighed scintillation vial. The aqueous phase was heated—with its solidified stearin layer interspersed atop—until all fatty materials melted. This heated aqueous phase was centrifuged (4700 rpm, 1 min, 40° C.) and the stearin fraction was also aspirated into a pre-weighed scintillation vial.

The separated olein and stearin fractions were weighed and their masses compared to the original mass of oil pre-fractionation. By mass, an exemplary microbial oil produced by R. toruloides was 68.4% w/w olein and 31.6% w/w stearin. By comparison, a crude plant-derived palm oil sample was analyzed as comprising 72% w/w olein and 28% w/w stearin using this fractionation method.

Next, the iodine value (IV) for each fraction was calculated, which is expressed as the number of grams of iodine absorbed by 100 g of the oil sample. The microbial olein fraction had an iodine value of 81 and the microbial stearin fraction had an iodine value of 22. The crude palm oil olein fraction had an IV of 53 and the stearin fraction had an IV of 40. These results indicate an even more distinct fractionation of saturated and unsaturated fatty acids between the microbial fractions, a distinction that could be useful for the manufacture of downstream products, as plant-derived palm oil may require multiple fractionation steps to achieve this level of differentiation between fractions.

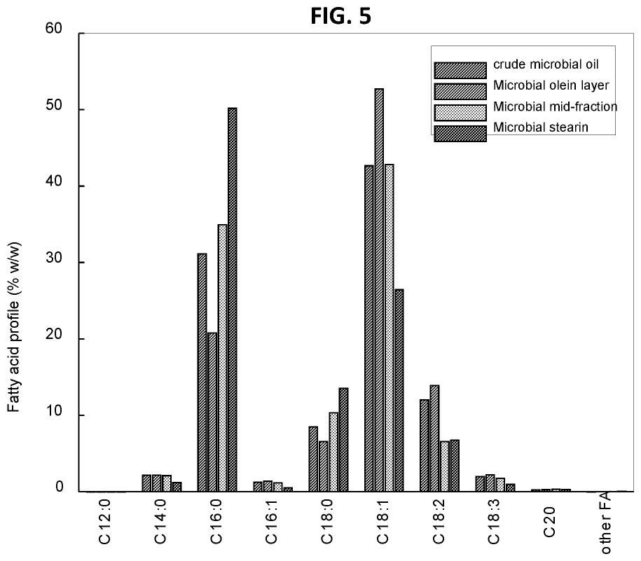

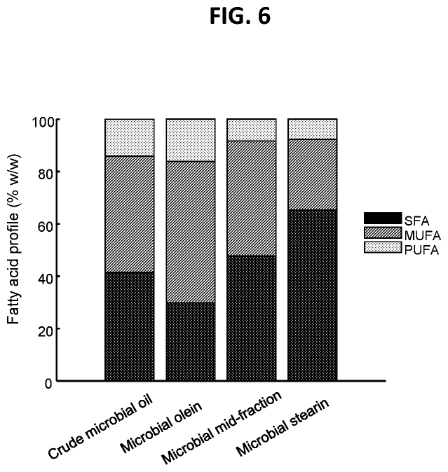

The fatty acid profile of the fractioned oil was also analyzed. Shown in FIG. 5 is a bar graph of the fatty acid profile of crude microbial oil, microbial olein layer, microbial mid-fraction, and microbial stearin layer. Shown in FIG. 6 is a bar graph of the saturated profiles of crude microbial oil, microbial olein layer, microbial mid-fraction, and microbial stearin layer. As shown in FIG. 6, Microbial olein has a greater percentage of monounsaturated fatty acids compared to microbial stearin, which has a greater percentage of saturated fatty acids. Thus, the edible microbial oil of the present disclosure may be fractioned similar to other plant-derived oils, such as palm oil.

Additionally, fractionated microbial olein and fractionated microbial stearin may replace palm olein and palm stearin in food products. Fractioned olein may also replace other vegetable oils high in oleic acids, such as, for example, high-oleic soybean oil, olive oil, canola oil, high-oleic sunflower oil, and high-oleic safflower oil.

### Example 9: Ester Production

Esterification is the general name for a reaction that generates esters, a compound derived from an acid. In some embodiments, the disclosure relates to esters derived from fatty acids produced by oleaginous yeast, wherein the esters are used in a food product.

Oil samples were converted into fatty acid methyl esters (FAMEs) and then analyzed using gas chromatography-mass spectrometry (GC-MS). A method of using commercial aqueous concentrated HCl (conc. HCl; 35%, w/w) as an acid catalyst was employed for preparation of fatty acid methyl esters (FAMEs) from microbial oil and palm oil for GC-MS. FAME preparation was conducted according to the following exemplary protocol.

Commercial concentrated HCl (35%, w/w; 9.7 ml) was diluted with 41.5 ml of methanol to make 50 ml of 8.0% (w/v) HCl. This HCl reagent contained 85% (v/v) methanol and 15% (v/v) water that was derived from conc. HCl and was stored in a refrigerator.

A lipid sample was placed in a screw-capped glass test tube (16.5×105 mm) and dissolved in 0.20 ml of toluene. To the lipid solution, 1.50 ml of methanol and 0.30 ml of the 8.0% HCl solution were added in this order. The final HCl concentration was 1.2% (w/v) or 0.39 M, which corresponded to 0.06 ml of concentrated HCl in a total volume of 2 ml. The tube was vortexed and then incubated at 45° C. overnight (14 h or longer) for mild methanolysis/methylation or heated at 100° C. for 1 h for rapid reaction. After cooling to room temperature, 1 ml of hexane and 1 ml of water were added for extraction of FAMEs. The tube was vortexed, and then the hexane layer was analyzed by GC-MS directly or after purification through a silica gel column.

For the analysis of fatty acid composition, a Shimadzu GCMS-TQ8040/GC-2010 Plus instrument was employed. The FAME samples were concentrated at 5 g/L in hexane/chloroform/heptane prior to analysis.

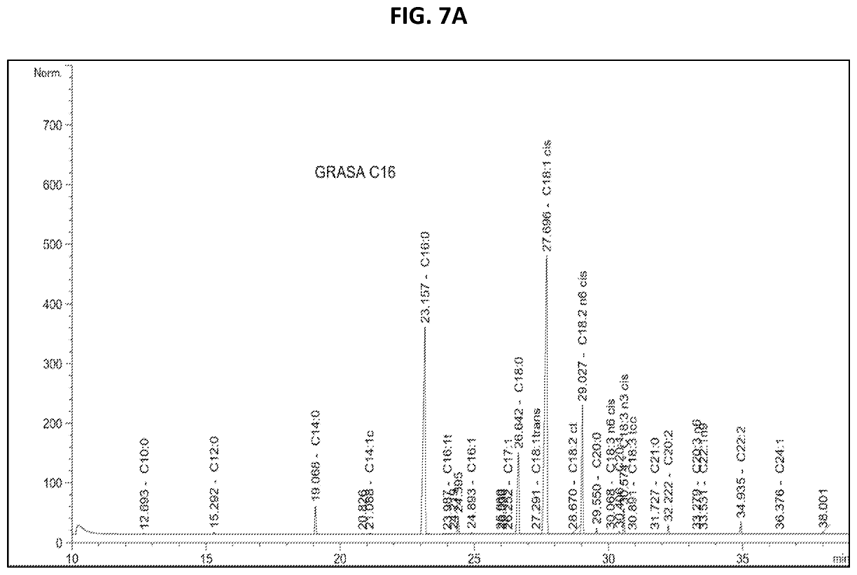

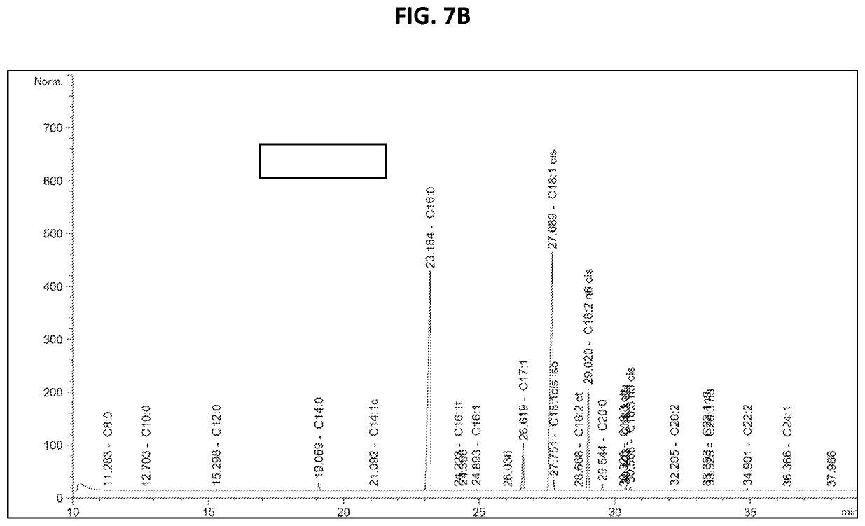

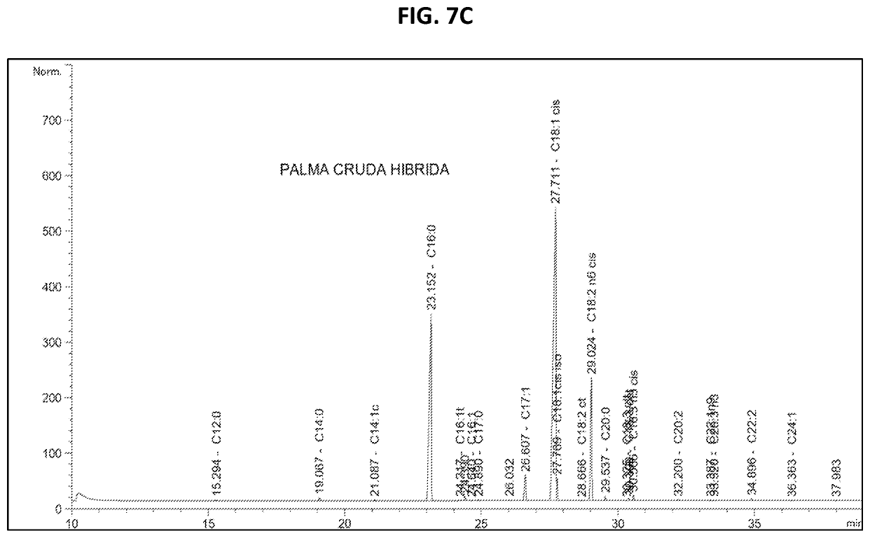

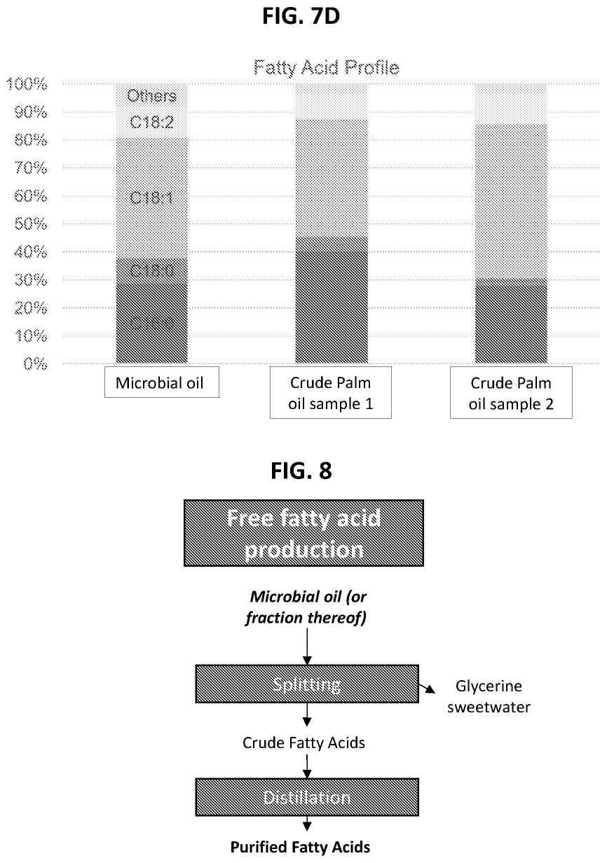

The results of the analysis are shown in Table 7 comparing the fatty acid composition of three exemplary microbial oil samples produced by Rhodosporidium toruloides to the measurements expected for crude palm oil, as set forth by guidelines from the Malaysian government. For Microbial oil sample 3, the fatty acid compositions were determined via fatty acid methyl ester analysis with a GC-SSL/FID (7890A, Agilent) instrument. The methods employed were using AOCS Ce 1a-13 and AOCS C2 2-66. (see also FIG. 7A-7D). Table 7 shows the breakdown of the individual fatty acid constituents by w/w percent, with the percentages for each sample adding up to 100%. Fatty acids that were assayed but not detected in any sample include C4, C6, C13, C15, C15:1, C18:2 tt, C18:2 5,9, C18:2 tc, C18:3, C18:3 ctc, C18:3 ttt, C18:3 ttc+tct, C20:4 n6ARA, C22, and C24.

TABLE 7
Fatty acid composition of microbial oil samples

| | Microbial | Microbial | Microbial | | |
|---|---|---|---|---|---|
| Fatty | oil | oil | oil | Palm oil | Palm oil |
| Acid | Sample 1 | Sample 2 | sample 3 | MIN | MAX |
| C8:0 | 0.0% | 0.0% | 0.0% | 0.0% | 0.1% |
| C10:0 | 0.0% | 0.0% | 0.04% | 0.0% | 0.1% |
| C12:0 | 0.2% | 0.0% | 0.17% | 0.0% | 0.5% |
| C14:0 | 1.8% | 1.7% | 2.24% | 0.5% | 2.0% |
| C15:1 | 0.5% | 0.5% | 0.0% | 0.0% | 0.1% |
| C16:0 | 14.5% | 13.8% | 28.7% | 39.3% | 47.5% |
| C16:1 | 0.6% | 0.7% | 0.10% | 0.0% | 0.6% |
| C17:0 | 10.2% | 9.5% | 0.0% | 0.0% | 0.2% |
| C17:1 | 0.8% | 0.6% | 0.03% | 0.0% | 0.1% |
| C18:0 | 26.9% | 28.8% | 8.98% | 3.5% | 6.0% |
| C18:1 | 10.0% | 16.3% | 43.39% | 36.0% | 44.0% |
| C18:2 | 15.2% | 16.1% | 10.77% | 9.0% | 12.0% |
| C20:0 | 8.3% | 3.6% | 0.0% | 0.0% | 0.0% |
| C18:3 | 0.2% | 0.0% | 1.75% | 0.0% | 0.5% |
| C20:1 | 2.5% | 0.4% | 0.13% | 0.0% | 0.4% |
| C22:0 | 2.6% | 0.7% | 0.0% | 0.0% | 0.2% |
| C22:1 | 0.3% | 0.3% | 0.02% | 0.0% | 0.0% |
| C22:2 | 0.3% | 0.0% | 0.94% | 0.0% | 0.0% |
| C24:0 | 5.0% | 7.1% | 0.0% | 0.0% | 0.0% |
| Other | | | 2.74% | | |

These results show that exemplary microbial oil samples of the present disclosure have a similar breakdown of saturated vs. unsaturated fatty acids compared to plant-derived palm oil, though the specific identities of the predominant fatty acids differs between the microbial samples and typical palm oil. Similar to palm oil, though, C16:0 was a significant source of saturated fatty acid in the microbial samples and C18 unsaturated fatty acids made up the majority of the unsaturated fatty acids in the sample.

The fatty acid composition breakdown of the samples were determined via fatty acid methyl ester analysis with a GC-SSL/FID (7890A, Agilent) instrument. The methods employed were using AOCS Ce 1a-13 and AOCS C2 2-66. The results these analyses are shown in Table 8. Table 8 below shows the breakdown of the individual fatty acid constituents by w/w percent, with the percentages for each sample adding up to 100%. Fatty acids that were assayed but not detected in any sample include C4, C6, C13, C15, C15:1, C18:2 tt, C18:2 5,9, C18:2 tc, C18:3, C18:3 ctc, C18:3 ttt, C18:3 ttc+tct, C20:4 n6ARA, C22, and C24.

TABLE 8
Fatty acid composition breakdown

| | | Crude | | |
|---|---|---|---|---|
| Condensed | | microbial | Crude palm | Crude hybrid |
| formula | Common name | oil | oil | palm oil |
| C8:0 | Caprylic | | 0.01% | |
| C10:0 | Capric | 0.04% | 0.01% | |
| C11:0 | Undecylic | 0.00% | | |
| C12:0 | Lauric | 0.17% | 0.11% | 0.08% |
| C14:0 | Myristic | 2.24% | 0.75% | 0.27% |
| C14:1c | Myristoleic | 0.08% | 0.05% | 0.06% |
| C16:0 | Palmitic | 28.70% | 40.20% | 27.79% |
| C16:1t | | 0.01% | 0.04% | 0.05% |
| C16:1 | Palmitoleic | 0.10% | 0.10% | 0.01% |
| C17:0 | Margaric | | | 0.08% |
| C17:1 | | 0.03% | | |
| C18:0 | Stearic | 8.98% | 5.15% | 2.65% |
| C18:1 trans | | 0.08% | | |
| C18:1 cis | Oleic | 43.39% | 42.09% | 55.21% |
| C18:1 cis iso | | | 0.59% | 1.11% |
| C18:2 ct | | 0.07% | 0.01% | 0.01% |
| C18:2 n6 cis | Linoleic | 10.77% | 9.61% | 11.23% |
| C18:3 ctt | | | 0.01% | 0.01% |
| C20:0 | Arachidic | 0.35% | 0.41% | 0.28% |
| C18:3 cct | | | 0.15% | 0.15% |
| C18:3 n6 cis | [symbol] -Linolenic | 0.05% | | |
| | (GLA) | | | |
| C18:3 tcc | | 0.01% | | |
| C20:1 | | 0.13% | | |
| C18:3 n3 cis | α-Linolenic | 1.69% | 0.30% | 0.39% |
| | (ALA) | | | |
| C21:0 | heneicosylic | 0.03% | | |
| C20:2 | cis-11,14- | 0.54% | 0.07% | 0.06% |
| | eicosadienoic | | | |
| C20:3 n6 | | 0.02% | | |
| C22:1 n9 | Erucic | 0.02% | 0.05% | 0.04% |
| C20:3 n3 | | | 0.02% | 0.02% |
| C22:2 | | 0.94% | 0.09% | 0.10% |
| C24:1 | | 0.04% | 0.01% | 0.01% |
| Unknown | | 1.20% | | |

Table 9 shows the w/w percentage of saturate, trans, mono-unsaturated, poly-unsaturated, and unknown fatty acids in each sample. The fatty acid compositions were determined via fatty acid methyl ester analysis with a GC-SSL/FID (7890A, Agilent) instrument. The methods employed were using AOCS Ce 1a-13 and AOCS C2 2-66. FIG. 7A-7C show the chromatograms for the crude microbial oil (FIG. 7A), palm oil (FIG. 7B), and hybrid palm oil (FIG. 7C), respectively. FIG. 7D shows a bar graph of representative compositions of microbial oil and palm oil.

TABLE 9
Overall fatty acid composition

| | Crude | Crude palm | Crude hybrid |
|---|---|---|---|
| | microbial oil | oil | palm oil |
| Saturated fatty acid | 40.5% | 41.5% | 28.5% |
| Trans fatty acid | 0.17% | 0.21% | 0.22% |
| Mono-unsaturated fatty | 43.8% | 48% | 59.1% |
| acid | | | |
| Poly-unsaturated fatty | 14% | 10.1% | 11.8% |
| acid | | | |
| Unknown | 1.5% | 0% | 0% |

As shown in the above and described herein, oleaginous microbial oil has a similar profile to that of palm oil, and thus esters derived from palm oil and used in food products may be substituted for esters derived from oleaginous yeast. Methods of producing esters from fatty acids are well known in the art. See, for example, Milinsk, M. C. et al., Comparative analysis of eight esterification methods in the quantitative determination of vegetable oil fatty acid methyl esters (FAME), J. Braz. Chem. Soc., 2008, vol. 19, n.8. One example use of the microbial oils described herein is esterification of a specific fatty acid produced from an oleaginous yeast, and use of the resultant ester as an ingredient or additive in a food product.

As shown in Table 8, oleaginous yeast produced approximately 9% stearic acid. Esterification of stearic acid produced by the oleaginous yeast described herein can produce stearate esters for use in food products. For example, a reaction with ethylhexyl alcohol can produce Ethylhexyl Stearate (also known as Octyl Stearate). Similarly, reactions with other alcohols can produce Butyl Stearate, Cetyl Stearate, Isocetyl Stearate, Isopropyl Stearate, Myristyl Stearate, and Isobutyl Stearate, and Octyldodecyl Stearoyl Stearate.

As shown above in Table 8 above, oleaginous yeast produced approximately 28.7% palmitic acid. Esterification of palmitic acid produced by the oleaginous yeast described herein can produce palmitate esters. For example, a reaction with ethylhexyl alcohol can produce ethylhexyl palmitate (also known as Octyl Palmitate). Similarly, Isopropyl Palmitate is the ester of isopropyl alcohol and palmitic acid. Cetyl Palmitate is the ester of cetyl alcohol and palmitic acid.

### Example 10: Free Fatty Acid and Fatty Alcohol Production

Hydrolysis is the process whereby triglycerides in fats and oils are split (“fat splitting” or “oil splitting”) into glycerol and fatty acids. It is usually carried out using great amounts of high-pressure steam (“steam hydrolysis”) but may also be performed using catalysts (for example, the tungstated zirconia and solid acid composite SAC-13 (Hydrolysis of Triglycerides Using Solid Acid Catalysts, Ngaosuwan, K, et al., Ind. Eng. Chem. Res., 2009 48 (10), 4757-4767)). The reaction proceeds in a step-wise fashion wherein fatty acids on triglycerides are displaced one at time, generating diglycerides, then monoglycerides, and finally free fatty acids and glycerin.

Shown in FIG. 8 is a flow diagram of an example method to produce purified fatty acids from microbial oil or fractions thereof. The crude microbial oil may first be deaerated to remove un-dissolved gasses. Next, the fatty acids are produced by steam hydrolysis, wherein the temperature is raised up to 260 degrees Celsius at a pressure of 60 bar. Glycerin may be collected and further purified for various uses, and the crude fatty acids are subsequently purified by distillation. Fatty acids may be further modified to produce, for example, conjugated fatty acids, dimer acids, fatty acids ethoxylates, and fatty acid esters.

Examples of fatty acids derived from oleaginous microorganisms that may be used in food products include, but are not limited to, myristic acid (C14), palmitic acid (C16), stearic acid (C18), and oleic acid (C18).

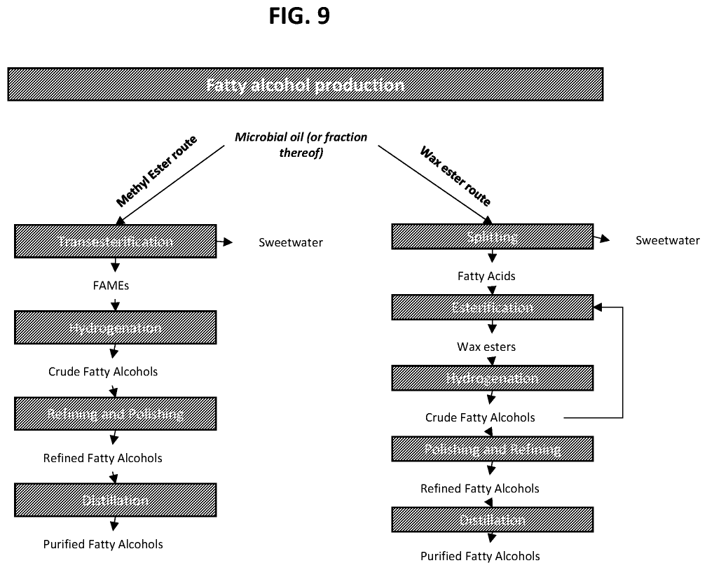

Fatty alcohols may be produced via a methyl ester route or a wax ester route (FIG. 9). In the methyl ester route (also known as the Davy process), FAMEs produced by transesterification may be hydrogenated to produce crude fatty alcohols, which are then refined, polished, and purified. In the wax ester route, (also known as the Lurgi process) fatty acids produced from hydrolysis (“splitting”) are further modified via esterification to produce wax esters, which may then be hydrogenated to produce fatty alcohols. Direct hydrogenation of fatty acids is also possible and produces fatty alcohols. Fatty alcohols may be further modified to produce, for example, fatty alcohol ethoxylates, and fatty alcohol sulfates.

Examples of fatty alcohols derived from oleaginous microorganisms that may be used in food products include, but are not limited to, palmityl alcohol, cetearyl alcohol, cetostearyl alcohol, stearyl alcohol, cetyl alcohol, isocetyl alcohol, isostearyl alcohol, myristyl alcohol, octyl decyl alcohol, octyl alcohol, decyl alcohol.

### Example 11: Fatty Acid Salt Production

Saponification is the process whereby triglycerides or free fatty acids used as feedstock are converted to fatty acids salts (soaps), glycerol, and free fatty acids in the presence of a base. The base may be for example, sodium hydroxide, or potassium hydroxide. Saponification may be achieved via a hot or cold process. The cold process uses the heat generated from the combination of the fatty acids in the melted oils and fats with sodium hydroxide (base). Methods of saponification are well known in the art.

The triglycerides or free fatty acids described herein (see for example, Table 8) may be used in a saponification reaction to produce salts, glycerin, and free fatty acids. For example, the fatty acid salt may be an aluminum salt, a sodium salt, a potassium salt, a calcium salt, or a magnesium salt. Magnesium stearate, for example is used as an emulsifier, binder, thickener, anticaking, lubricant, release, and/or antifoaming agent in a food product. Thus, it may be an ingredient or an additive in a supplement, spice, confectionery, chewing gum, or baking ingredient.

As will be understood by one skilled in the art, saponification of the triglycerides disclosed herein may produce a number of salts and glycerin for use in food products.

### Unsaponifiable Lipid Content

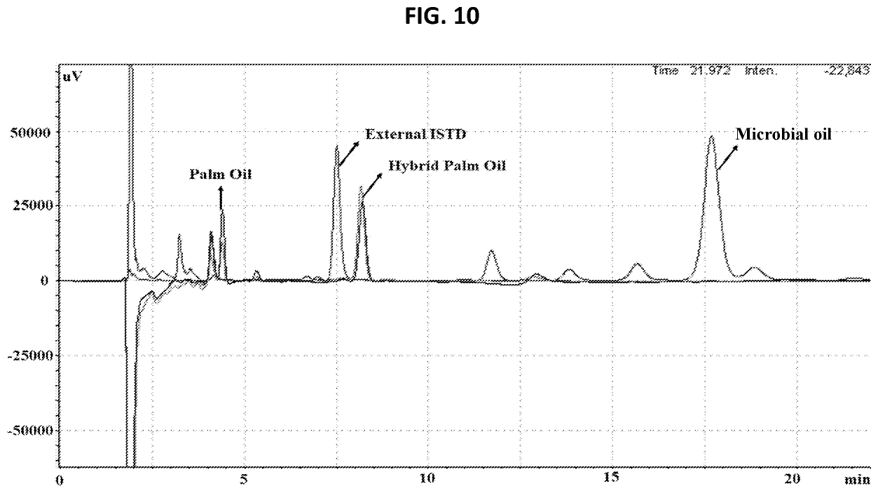

The unsaponifiable lipid content of the three microbial oil samples was analyzed, specifically measuring the amount of beta-carotene (data not shown), squalene, tocopherols, and sterols in each sample. Results are shown in Table 10. Beta-carotene was analyzed using the method of Luterotti et al., “New simple spectrophotometric assay of total carotenes in margarines,” Analytica Chimica Acta 2006; 573:466-473, incorporated by reference herein in its entirety. The sterol composition was analyzed using the method of Johnsson et al., “Side-chain autoxidation of stigmasterol and analysis of a mixture of phytosterol oxidation products by chromatographic and spectroscopic methods,” Journal of the American Oil Chemists' Society 2003; 80(8):777-83, incorporated by reference herein in its entirety, with the HPLC-DAD chromatogram results shown in FIG. 10. The other methods that were employed are indicated in Table 10. The sterol composition of the microbial oil sample showed an atypical sterols chromatographic profile differentiating it from the palm oil and hybrid palm oil samples and warranting further investigation. In this illustrative sample, the unexpected sterol composition acts as a unique fingerprint for the microbial oil sample.

TABLE 10
Unsaponifiable lipid content

| | | | Crude | | Crude |
|---|---|---|---|---|---|
| | | | microbial | Crude | hybrid |
| Parameter | Method | Equipment | oil | palm oil | palm oil |
| Squalene | AOCS Ce 1a- | GC-SSL/FID | 122 | 389 | 260 |
| (ppm) | 13 | (7890A, Agilent) | | | |
| Tocopherols | AOCS Ce 8-89 | LC-DAD/RID | <10 | 869 | 761 |
| (ppm) | | (Prominence, | | | |
| | | Shimadzu) | | | |
| Sterols (%) | Johnsson et al. | GC-COC/FID | Unexpected | 0.07 | 0.1 |
| | | (7890A, Agilent) | profile | | |

As shown in Table 10, the microbial oil sample does not contain significant levels of unsaponifiable lipids, or tocopherols. Specifically, microbial oil has approximately 122 ppm of squalene, compared to 389 ppm and 260 ppm in palm oil and hybrid palm oil respectively. Microbial oil also contained less than 10 ppm of tocopherols, whereas palm oil and hybrid palm oil contained 869 ppm and 761 ppm respectively.

### Example 12: Edible Microbial Oil

Edible microbial oil was prepared using R. toruloides fermented on glycerol feed, lysed with acid, and extracted with heptane solvent. The composition of the oil is shown below in Table 11.

TABLE 11
Oil batch analysis

| Batch ID | D011-F007 | D015-F008 | D009-F006 |
|---|---|---|---|
| Used for | Burger, biscuit, | Cookies | Peanut |
| | chocolate spread | | butter |
| Yellow Color (Lovibond) | 50 | 50 | 50 |
| Red Color (Lovibond) | 20 | 20 | 20 |
| Density, g/cc | 0.904 | 0.905 | 0.904 |
| Refractive index | 1.4639 | 1.4631 | 1.4637 |
| Melting point, C. | 21 | 22 | 21 |
| Smoke point, F. | 381 | 365 | 353 |
| C10% | 0.47 | 0.12 | 0.23 |
| C12% | 0 | 0 | 0 |
| C14% | 1.39 | 1.75 | 1.27 |
| C16% | 32.17 | 32.81 | 28.1 |
| C16:1% | 1.41 | 1.08 | 1.1 |
| C18% | 6.21 | 7.67 | 8.19 |
| C18:1% | 45.08 | 45 | 47.33 |
| C18:2% | 11.12 | 10.03 | 10.68 |
| C18:3% | 1.93 | 1.38 | 1.6 |
| C20% | 0.24 | 0.17 | 1.5 |
| SFA % | 40.47 | 42.52 | 39.29 |
| MUFA % | 46.48 | 46.08 | 48.43 |
| PUFA % | 13.05 | 11.41 | 12.28 |
| Unsaponifiable matter % | 0.89 | 1.11 | 0.54 |
| FFA % Oleic | 2.36 | 2.37 | 2.41 |
| Iodine value GI/100 g | 67 | 68.8 | 69.1 |
| Saponification value, mg | 194 | 189 | 194 |
| KOH/g | | | |
| Peroxide value, meg/kg | 0.484 | 1.37 | 0.906 |
| Arsenic, mg/kg | <0.010 | <0.010 | <0.010 |
| Cadmium, mg/kg | <0.005 | <0.005 | <0.005 |
| Lead, mg/kg | <0.005 | <0.005 | 0.0093 |
| Mercury, mg/kg | <0.005 | <0.005 | <0.005 |
| Phosphorus, mg/kg | 26 | | 33 |
| Heptane, mg/kg | 669.05 | 1,661.94 | 857.7 |
| Hexane, mg/kg | <0.50 | <0.50 | <0.50 |

### Example 13: Peanut Butter Made with Edible Microbial Oil

Peanut butter is an ideal food for many reasons. It's high protein content makes it an excellent choice for vegetarians and vegans, and its portability and lack of refrigeration make it easily transportable and a pantry stable. It's also relatively inexpensive. Because of these qualities, ready-to-use packets of peanut butter further enriched with vitamins and minerals are even being used as Therapeutic Food to treat severe acute malnutrition in young children.

Peanut butter became popular during the great Depression, after WWII, and most recently sales increased during the COVID19 pandemic. Americans consume an average of three pounds of peanut butter per person per year. In addition to the classic PB&J, peanut butter is used as an ingredient in baked goods, nutrient bars, candy, savory dishes like Pad Thai, and ad a condiment on food such as burgers, oatmeal, and fruit like apples and bananas.

“Nut butter” refers to a product that contains at least 90% nut ingredients, whereas “nut spread” refers to a product having at least 40% nut ingredients. Examples of other nuts that may be used for butters and spreads include, but are not limited to, hazelnut, pistachio, almond, and cashew. Both nut butters and spreads are made from nuts ground to a paste, and often mixed with sugar, salt, oils and emulsifiers to improve taste and spreadability. Spreadability is one of the most important characteristics of nut butters and spreads, as creamy and smooth nut butters are preferred by consumers. Spreadability is a subjective term related to how easy a sample is uniformly distributed over a surface. Other important qualities of peanut butter include texture, color, flavor and nutritive value.

Vegetable oils, such as hydrogenated soybean oil and palm oil are often added to help stabilize peanut butter and prevent oil separation (Gills, L. A. and Anna V. A. Resurreccion. “Overall Acceptability and Sensory Profiles of Unstabilized Peanut Butter and Peanut Butter Stabilized with Palm Oil.” Journal of Food Processing and Preservation 24 (2000): 495-516; Gills, L. A. and Anna V. A. Resurreccion. “Sensory and Physical Properties of Peanut Butter Treated with Palm Oil and Hydrogenated Vegetable Oil to Prevent Oil Separation.” Journal of Food Science 65 (2000): 173-180).

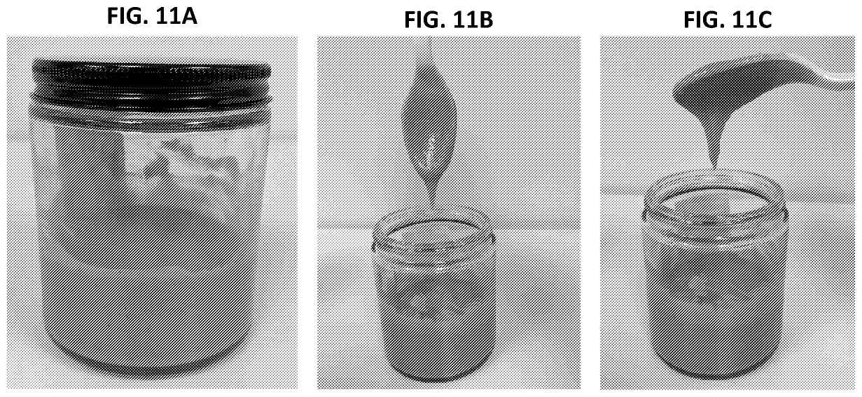

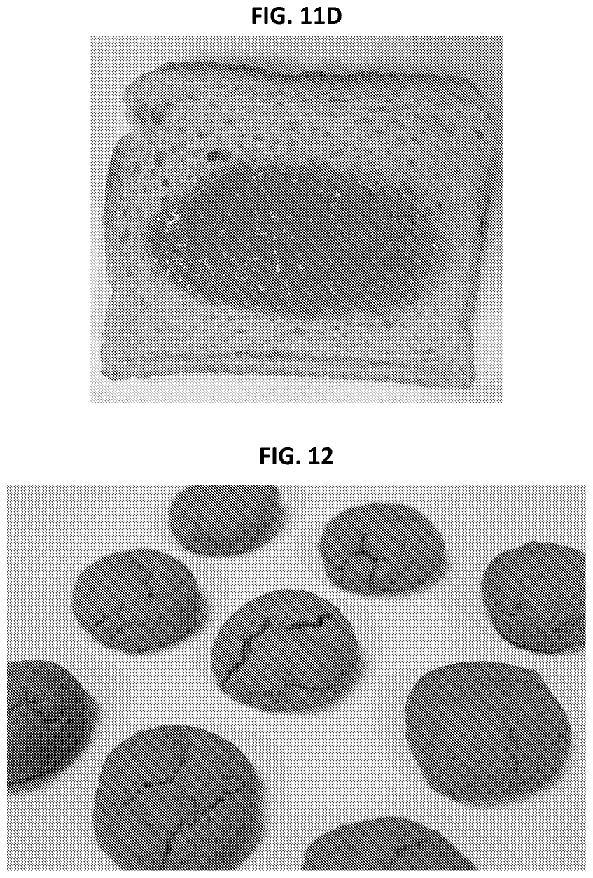

To make peanut butter, 98 g of dry roasted peanuts were placed in a food processor and run until a smooth peanut butter was formed (between 4 and 5 minutes). This was then mixed with 2 g of microbial oil obtained from R. toruloides prepared as described above in Example 12. The resulting peanut butter, shown in FIGS. 11A-11D had an appearance, texture, spoonability, and spreadability similar to that of peanut butter made with vegetable oil.

While not shown here, additional ingredients, such as sugar, salt, flavorings (for example chocolate) could be added.

### Example 14: Baked Goods Made with Edible Microbial Oil

Edible microbial oil was obtained and prepared as described above in Example 12.

Using the sugar cookie recipe below, oil and egg were mixed in a bowl. The sugar was added and mixed well, followed by the flour, baking powder, and salt and mixed until a dough formed. The cookie dough was weighed out (30 g per cookie) and placed on a foil lined baking tray and baked for 8 minutes at 400° F.

### Sugar Cookies

1 egg
⅓ cup edible microbial oil (isolated from R. toruloides)
6 tbsp white sugar
1 cup flour
1 tsp baking powder
¼ tsp salt

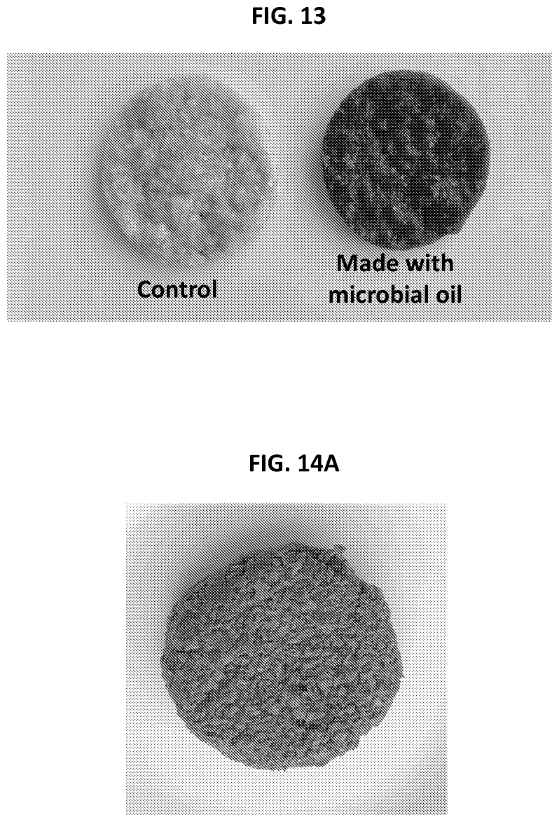

The resulting cookies (FIG. 12) had a similar appearance, taste, and texture to cookies made with vegetable oil. Another baked good, biscuits, were made using edible microbial oil in place of palm oil (shown in FIG. 13).

### Example 15: Plant-Based Burger Made with Edible Microbial Oil

Plant based diets and foods are increasing in popularity for a number of reasons, such as the health benefits that come from eating more vegetables and grains, and the positive effects on the environment from the reduction on the reliance on animals for protein. One of the more popular plant-based food items are the meatless burgers. Generally, these burger alternatives are composed of grains, legumes (such as soy), other vegetables, and fats-added for flavor and texture. Coconut oil and palm oil are two common ingredients found in plant-based burgers.

The edible microbial oil was prepared as described above in Example 12, and used to make a meat substitute burger using the recipe below. A control patty was also made using the same recipe, but 12% w/w canola and 7% w/w coconut oil place of the microbial oil. The texturized soy protein was rehydrated with hot water and combined with the remaining ingredients in a bowl.

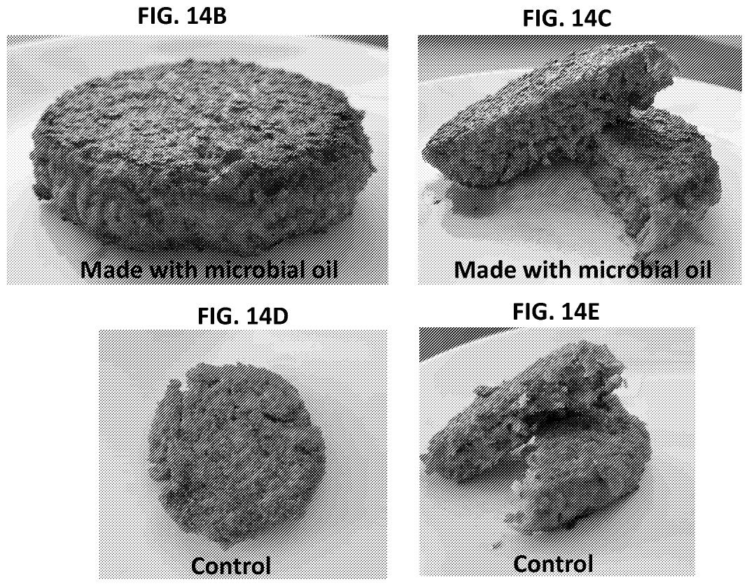

Water was added as needed until the mixture could be formed into patties (shown in FIG. 14A), which were then fried in oil over medium heat. The cooked patties are shown in FIGS. 14B and 14C, with the control cooked patties shown in FIGS. 14D and 14E.

### Meat Substitute Burger

Extrudate (texturized soy protein): 20-21%
Natural flavor: 3-3.5%
Natural color: 0.24-0.4%
Binder (cellulose fiber): 2.5-3%
Water: 54-56%
edible microbial oil (isolated from R. toruloides): 19%

### Example 16: Chocolate Spread Made with Edible Microbial Oil

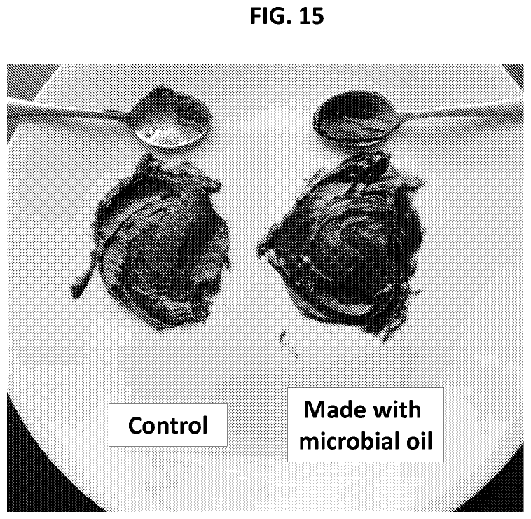

Sugar and palm oil are the two first ingredients in some versions of chocolate spreads, with palm oil comprising 20% or more of the product. The edible microbial oil was prepared as described above in Example 12, and used to make a chocolate spread using the recipe below. A control chocolate spread was also made using the same recipe, but with vegetable oil in place of the microbial oil. The control version and that made with microbial oil are shown in FIG. 15.

### Chocolate Spread

Sugar
Edible microbial oil (derived from an oleaginous yeast)
Hazelnuts
Cocoa
Soy lecithin
Vanilla

### Example 15: Other Food Products that May be Produced Using Microbial Oil and/or Derivatives Thereof

Listed below are several example recipes for food products using the edible microbial oil and/or derivatives thereof described herein as ingredients or additives. The recipes below are examples and should not be construed as limiting. Rather, these examples are provided so that this disclosure will be thorough and complete. Additional uses for the edible microbial oils and derivatives thereof, and various modifications to the example recipes below will be readily apparent to those skilled in the art. Specifically, any composition comprising a vegetable oil, (for example, palm oil, palm kernel oil, coconut oil, almond oil, canola oil, cocoa butter, corn oil, olive oil, peanut oil, safflower oil, soybean oil, walnut oil, etc.) or derivatives thereof, may be substituted for an edible microbial oil or derivative thereof.

### Vegan Milk Alternative

Nuts (e.g. almonds, cashews)
Water
Edible microbial oil
Salt
Optional flavoring agents (e.g. vanilla extract; chocolate; fruit)

### Processed Cheese

Skim milk
Edible microbial oil (derived from an oleaginous yeast)
Milk protein concentrate
Sodium phosphate
Starch
Maltodextrin
Why
Salt
Calcium phosphate
Lactic acid
Sorbic acid
Whey protein concentrate
Milkfat
Sodium citrate
Cheese culture
Vitamin A palmitate (derived from an oleaginous yeast)

### Vegan Cheese-Like Product

Nuts (e.g. cashews, almonds, macadamias)
Edible microbial oil or fraction thereof (derived from an oleaginous yeast)
Nutritional yeast
Agar flakes
Supplementary protein source (e.g. soy)
Miso paste (optional)
Bacterial cultures (optional)

### Ice Cream

Milk
Cream
Sugar
Egg yolks
Whey
Vegetable gums
Mono and diglycerides (derived from an oleaginous yeast)
Vanilla
Salt

### Vegan Ice-Cream

Edible microbial oil (derived from an oleaginous yeast)
Vegan milk alternative (e.g. nutmilk, optionally derived from an oleaginous yeast)
Sweetener (e.g. sugar; honey; agave syrup; maple syrup)
Cornstarch
Vanilla extract
Salt
Optional flavoring agents (e.g. nuts, fruit, chocolate)

### Chocolate Syrup

High fructose corn syrup
Corn syrup
Water
Cocoa
Sugar
Potassium sorbate
Xanthan gum
Salt
Mono and diglycerides (derived from an oleaginous yeast)
Polysorbate 60 (derived from an oleaginous yeast)
vanilla

### Margarine

Vegetable oil (for example soybean oil)
Edible microbial oil (derived from an oleaginous yeast)
Salt
Potassium sorbate
Soy lecithin
Mono and diglycerides (derived from an oleaginous yeast)
Lactic acid
Vitamin A palmitate (derived from an oleaginous yeast)
Beta-carotene (derived from an oleaginous yeast)

### Chocolate or Chocolate Countline Coating

Cocoa powder
Sugar
Edible microbial oil (derived from an oleaginous yeast)
Vanilla extract
Salt

### CONCLUSION

Based on the above analyses, the microbial oil described herein is a good match for vegetable oils such as palm oil, along a number of different parameters, demonstrating its suitability for use as an environmentally friendly alternative to plant-derived oils for consumption and use in food products.

### Numbered Embodiments of the Invention

Notwithstanding the appended claims, the disclosure sets forth the following numbered embodiments:
1. A refined, bleached, and/or deodorized (RBD) microbial oil produced by an oleaginous yeast.
2. A refined, bleached, and/or deodorized (RBD) microbial oil produced by an oleaginous yeast, wherein the microbial oil comprises ergosterol and does not comprise campesterol, β-sitosterol, or stigmasterol.
3. The microbial oil of embodiment 1 or 2, wherein a measurable amount of the pigment remains.
4. The microbial oil of embodiment 3, wherein the oil comprises at least one pigment selected from the group consisting of carotene, torulene and torulorhodin and does not comprise chlorophyll.
5. The microbial oil of any one of embodiments 1-4, wherein the oil is fractionable into two fractions, wherein the two fractions are microbial olein and microbial stearin, wherein each fraction comprises at least 10% of the microbial oil's original mass, and wherein the iodine value (IV) of the fractions differs by at least 10.
6. The microbial oil of any one of embodiments 1-5, wherein the oil has one or more characteristics similar to plant-derived palm oil selected from the group consisting of: apparent density, refractive index, saponification value, unsaponifiable matter, iodine value, slip melting point, and fatty acid composition.
7. A microbial oil produced by an oleaginous yeast, wherein the oil comprises a fatty acid profile comprising:
   at least 30% w/w saturated fatty acids;
   at least 30% w/w unsaturated fatty acids; and
   less than 30% w/w total polyunsaturated fatty acids.
8. The microbial oil of embodiment 7, wherein the fatty acid profile comprises:
   greater than 40% w/w saturated fatty acids;
   greater than 40% w/w mono-unsaturated fatty acids; and
   less than 20% w/w polyunsaturated fatty acids.
9. The microbial oil of embodiment 7 or 8, wherein the saturated fatty acids have chain lengths between 16 and 18 carbons long.
10. The microbial oil of embodiment 7 or 8, wherein the unsaturated fatty acids have a chain length of 18 carbons.
11. The microbial oil of any one of embodiments 7-10, wherein the oil comprises ergosterol, at least 50 ppm ergosterol, or at least 100 ppm ergosterol.
12. The microbial oil of any one of embodiments 7-11, wherein the oil does not contain a phytosterol or chlorophyll.
13. The microbial oil of any one of embodiments 7-12, wherein the oil has one or more characteristics similar to plant-derived palm oil selected from the group consisting of iodine value, slip melting point, and overall saturation level.
14. The microbial oil of any one of embodiments 7-13, wherein the oil comprises 10-45% C16 saturated fatty acid.
15. The microbial oil of any one of embodiments 7-14, wherein the oil comprises 10-70% C18 unsaturated fatty acid.
16. The microbial oil of any one of embodiments 7-14, wherein the oil comprises 3-30% C18 saturated fatty acid.
17. The microbial oil of any one of embodiments 7-16, wherein the oil comprises a saponification value similar to that of plant-derived palm oil.
18. The microbial oil of any one of embodiments 7-17, wherein the oil comprises a saponification value of 150-210.
19. The microbial oil of any one of embodiments 7-18, wherein the oil comprises an iodine value similar to that of plant-derived palm oil.
20. The microbial oil of any one of embodiments 7-19, wherein the oil comprises an iodine value of 50-65.
21. The microbial oil of any one of embodiments 7-20, wherein the oil comprises a slip melting point similar to that of plant-derived palm oil.
22. The microbial oil of any one of embodiments 7-21, wherein the oil comprises a slip melting point of 20° C.-40° C.
23. The microbial oil of any one of embodiments 7-22, wherein the oil comprises a saturated fatty acid composition similar to that of plant-derived palm oil.
24. The microbial oil of any one of embodiments 7-23, wherein the oil comprises a saturated fatty acid composition of at most 70%.
25. The microbial oil of any one of embodiments 7-24, wherein the oil comprises an unsaturated fatty acid composition similar to that of plant-derived palm oil.
26. The microbial oil of any one of embodiments 7-25, wherein the oil comprises an unsaturated fatty acid composition of at most 70%.
27. The microbial oil of any one of embodiments 7-26, wherein the oil comprises less than 100 ppm of, comprises less than 50 ppm of, or does not comprise a phytosterol.
28. The microbial oil of embodiment 27, wherein the phytosterol is selected from the group consisting of campesterol, β-sitosterol, stigmasterol.
29. The microbial oil of any one of embodiments 7-28, wherein the oil comprises less than 100 ppm of, comprises less than 50 ppm of, or does not comprise cholesterol.
30. The microbial oil of any one of embodiments 7-29, wherein the oil comprises less than 100 ppm of, comprises less than 50 ppm of, or does not comprise protothecasterol.
31. The microbial oil of any one of embodiments 7-30, wherein the oil does not comprise a pigment.
32. The microbial oil of any one of embodiments 7-30, wherein the oil comprises at least one pigment selected from the group consisting of β-carotene, torulene and torulorhodin.
33. The microbial oil of embodiment 32, wherein the oil comprises each of β-carotene, torulene and torulorhodin.
34. The microbial oil of any one of embodiments 7-33, wherein the oleaginous yeast is a recombinant yeast.
35. The microbial oil of any one of embodiments 7-34, wherein the oleaginous yeast is of the genus Yarrowia, Candida, Rhodotorula, Rhodosporidium, Metschnikowia, Cryptococcus, Trichosporon, or Lipomyces.
36. The microbial oil of any one of embodiments 7-35, wherein the oleaginous yeast is of the genus Rhodosporidium.
37. The microbial oil of any one of embodiments 7-36, wherein the oleaginous yeast is of the species Rhodosporidium toruloides.
38. The microbial oil of any one of embodiments 7-37, wherein the oil is fractionable.
39. The microbial oil of any one of embodiments 7-38, wherein the oil may be fractionated into microbial olein and microbial stearin.
40. The microbial oil of any one of embodiments 7-39, wherein the oil may be fractionated into microbial olein and microbial stearin, and wherein each fraction comprises at least 10% of the composition's starting mass.
41. The microbial oil of any one of embodiments 7-40, wherein the oil may be fractionated into microbial olein and microbial stearin, and wherein the iodine value (IV) of the fractions differs by at least 10.
42. The microbial oil of any one of embodiments 7-40, wherein the oil may be fractionated into microbial olein and microbial stearin, and wherein the IV of the fractions differs by at least 20.
43. The microbial oil of any one of embodiments 7-40, wherein the oil may be fractionated into microbial olein and microbial stearin, and wherein the IV of the fractions differs by at least 30.
44. The microbial oil of any one of embodiments 7-43, wherein the oil comprises at least 10% w/w C16 saturated fatty acid.
45. The microbial oil of any one of embodiments 7-44, wherein the oil comprises at least 10% w/w C18 unsaturated fatty acid.
46. The microbial oil of any one of embodiments 7-44, wherein the oil comprises at least 20% w/w C18 unsaturated fatty acid.
47. The microbial oil of any one of embodiments 7-46, wherein the oil comprises less than 5% combined C8, C10, C12, C14, and C15 saturated fatty acids.
48. The microbial oil of any one of embodiments 7-47, wherein the oil comprises:
   less than 10% w/w palmitic-palmitic-palmitic triglycerides;
   greater than 15% w/w palmitic-palmitic-oleic triglycerides; and
   greater than 15% w/w oleic-oleic-palmitic triglycerides.
49. The microbial oil of embodiment 48, wherein said palmitic-palmitic-palmitic triglyceride content is between about 0.8% and 1.3% w/w.
50. The microbial oil of embodiment 48, wherein said palmitic-palmitic-oleic triglyceride content is between about 16.9% and 28.2% w/w.
51. The microbial oil of embodiment 48, wherein said oleic-oleic-palmitic triglyceride content is between about 15.7% and 26.0% w/w.
52. The microbial oil of any one of embodiments 48-51, further comprising a stearic-stearic-oleic triglyceride content of less than 10% w/w and a stearic-oleic-oleic triglyceride content of less than 10% w/w.
53. The microbial oil of embodiment 52, wherein said stearic-stearic-oleic triglyceride content is between about 1.2% and 1.9% w/w.
54. The microbial oil of embodiment 52, wherein said stearic-oleic-oleic triglyceride content is between about 3.2% and 5.4% w/w.
55. The microbial oil of any one of embodiments 48-54, wherein greater than 40% of said triglycerides have one unsaturated sidechain, and wherein greater than 30% of said triglycerides have two unsaturated sidechains.
56. The microbial oil of any one of embodiments 48-55, wherein between 10% and 15% of palmitic and/or stearic fatty acids are located at the sn-2 position of triglyceride molecules.
57. The microbial oil of any one of embodiments 7-56, wherein the oil comprises the following amounts of fatty acids relative to the total fatty acids:
   between about 7.0% and 35% stearic acid;
   between about 10% and 50% oleic acid; and
   between about 8% and 20% linoleic acid.
58. The microbial oil of any one of embodiments 7-57, wherein the oil has been refined.
59. The microbial oil of embodiment 58, wherein the oil has been chemically and/or physically refined.
60. The microbial oil of embodiment 58 or 59, wherein the oil is deodorized.
61. The microbial oil of any one of embodiments 58-60, wherein the oil is bleached.
62. A derivative of the oil of any one of embodiments 1-61, wherein the derivative is a fraction, and wherein the fraction is microbial stearin, microbial olein, microbial soft mid-fraction, microbial super olein, microbial hard mid-fraction, microbial olein, and/or microbial top olein.
63. The microbial stearin of embodiment 62, wherein the stearin has a slip melting point of greater than 25° C.
64. A food product comprising the microbial olein of embodiment 62.
65. A blended fat composition, wherein said composition comprises a vegetable oil lipid source, and at least 1% of the edible microbial oil and/or a derivative thereof of any one of embodiments 62-64.
66. The blended fat composition of embodiment 65, wherein the vegetable oil lipid is soybean oil, corn oil, rapeseed oil, canola oil, sunflower oil, safflower oil, coconut oil, rice bran oil, olive oil, sesame oil, flaxseed oil, hemp oil, or cottonseed oil.
67. The blended fat composition of embodiment 65, wherein the vegetable oil lipid is peanut oil, almond oil, beech nut oil, brazil nut oil, cashew oil, hazelnut oil, macadamia oil, mongongo nut oil, pecan oil, pine nut oil, pistachio oil, walnut oil, or pumpkin seed oil.
68. The blended fat composition of embodiment 65, wherein the vegetable oil lipid is grapefruit seed oil, lemon oil, apricot oil, apple seed oil, argan oil, avocado oil, or orange oil.
69. The blended fat composition of any one of embodiments 65-68, wherein the composition is a cooking oil, frying oil, shortening, margarine, or butter-like product.
70. The blended fat composition of any one of embodiments 65-69, wherein the composition does not comprise palm oil or palm kernel oil.
71. A palm oil substitute comprising the edible microbial oil of any one of embodiments 7-61, the derivative of any one of embodiments 62-64, or the blended fat composition of any one of embodiments 65-70.
72. The edible microbial oil of any one of embodiments 7-61, the derivative of any one of embodiments 62-64, or the blended fat composition of any one of embodiments 65-70, wherein the edible oil, derivative, or blended fat composition has one or more characteristics similar to plant-derived palm oil selected from the group consisting of: apparent density, refractive index, oxidative stability, saponification value, unsaponifiable matter, iodine value, slip melting point, fatty acid composition, triglyceride content, overall saturation level, and level of mono- and poly-unsaturated fatty acids.
73. The edible microbial oil of any one of embodiments 7-61, the derivative of any one of embodiments 62-64, or the blended fat composition of any one of embodiments 65-70, wherein the edible oil, derivative, or blended fat composition comprises a slip melting point of 30° C.-40° C.
74. A food product comprising the edible microbial oil of any one of embodiments 7-61, the derivative of any one of embodiments 62-64, or the blended fat composition of any one of embodiments 65-70.
75. The food product of embodiment 74, wherein the food comprises between 0.1% and 30% edible microbial oil derivative, and/or blended fat composition.
76. The food product of embodiment 74 or 75, wherein the food product is a nut butter or spread.
77. The food product of embodiment 74 or 75, wherein the food product is a chocolate product or a chocolate countline product.
78. The food product of embodiment 74 or 75, wherein the food product is a baked good.
79. The food product of embodiment 74 or 75, wherein the food product is a meat substitute.
80. The food product of embodiment 79, wherein the meat substitute is a ground-beef-like product.
81. The food product of embodiment 74 or 75, wherein the food product is an animal fat substitute.
82. The food product of any one of embodiments 79-81, further comprising at least one of an edible gum, a starch, and a gelling agent.
83. The food product of embodiment 74 or 75, wherein the food product is a cheese-like sub stance.
84. The food product of embodiment 74 or 75, wherein the food product is a milk-like product.
85. The food product of embodiment 74 or 75, wherein the food product is an infant formula.
86. The food product of any one of embodiments 74-85, wherein the food product does not comprise palm oil or palm kernel oil.
87. The food product of any one of embodiments 74-86, wherein the food product does not comprise animal fat.
88. A method for producing an edible microbial oil comprising:
   obtaining a whole cell or lysed microbial biomass; and
   extracting crude microbial oil from the whole cell or lysed microbial biomass, wherein said extraction process removes toxins and produces a microbial oil safe for human consumption.
89. The method of embodiment 88, further comprising at least one of physically refining, chemically refining, deodorizing and bleaching the microbial oil.
90. The method of embodiment 88 or 89, further comprising modifying the microbial oil, wherein said modifying comprises fractionation, interesterification, transesterification, hydrogenation, steam hydrolysis, distillation, saponification, or combinations thereof.
91. The method of embodiment 90, wherein the method produces a derivative selected from a triglyceride, diglyceride, monoglyceride, free fatty acid, fatty acid salt, glycerin, ester, fatty alcohol, fatty amine, derivative thereof, and combinations thereof.
92. The method of any one of embodiments 88-91, wherein the edible microbial oil further comprises ergosterol, β-carotene, torulene, and/or torularhodin.
93. The method of any one of embodiments 88-92, wherein the whole cell or lysed microbial biomass is produced by Rhodosporidium toruloides.
94. A method for producing a food product comprising an edible microbial oil and/or a derivative thereof comprising:
   obtaining an edible microbial oil, and/or a derivative thereof, wherein said oil is produced from an oleaginous yeast;
   using the microbial oil and/or derivative thereof as an ingredient in a food product; and
   producing a food product.
95. The method of embodiment 94, wherein the edible microbial oil is produced by Rhodosporidium toruloides.
96. The method of embodiment 94 or 95, wherein the food product is a nut butter or spread, a chocolate product, a baked good, a meat substitute, a cheese-like product, a milk-like product, an infant formula, a cooking oil, shortening, margarine, or butter-like product.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgement or any form of suggestion that they constitute valid prior art or form part of the common general knowledge in any country in the world. The following international PCT publications are incorporated herein by reference in their entirety: International Patent Publication No. WO2021/154863 and WO2021/163194.

What is claimed is:

1. A refined, bleached, and/or deodorized (RBD) microbial oil produced by an oleaginous yeast.

2. A refined, bleached, and/or deodorized (RBD) microbial oil produced by an oleaginous yeast, wherein the microbial oil comprises ergosterol and does not comprise campesterol, β-sitosterol, or stigmasterol.

3. The microbial oil of claim 1, wherein a measurable amount of the pigment remains.

4. The microbial oil of claim 3, wherein the oil comprises at least one pigment selected from the group consisting of carotene, torulene and torulorhodin and does not comprise chlorophyll.

5. The microbial oil of claim 1, wherein the oil is fractionable into two fractions, wherein the two fractions are microbial olein and microbial stearin, wherein each fraction comprises at least 10% of the microbial oil's original mass, and wherein the iodine value (IV) of the fractions differs by at least 10.

6. The microbial oil of claim 1, wherein the oil has one or more characteristics similar to plant-derived palm oil selected from the group consisting of: apparent density, refractive index, saponification value, unsaponifiable matter, iodine value, slip melting point, and fatty acid composition.

7. A microbial oil produced by an oleaginous yeast, wherein the oil comprises a fatty acid profile comprising:
at least 30% w/w saturated fatty acids;
at least 30% w/w unsaturated fatty acids; and
less than 30% w/w total polyunsaturated fatty acids.

8. The microbial oil of claim 7, wherein the fatty acid profile comprises:
greater than 40% w/w saturated fatty acids;
greater than 40% w/w mono-unsaturated fatty acids; and
less than 20% w/w polyunsaturated fatty acids.

9. The microbial oil of claim 7, wherein the saturated fatty acids have chain lengths between 16 and 18 carbons long.

10. The microbial oil of claim 7, wherein the unsaturated fatty acids have a chain length of 18 carbons.

11. The microbial oil of claim 7, wherein the oil comprises ergosterol, at least 50 ppm ergosterol, or at least 100 ppm ergosterol.

12. The microbial oil of claim 7, wherein the oil does not contain a phytosterol or chlorophyll.

13. The microbial oil of claim 7, wherein the oil has one or more characteristics similar to plant-derived palm oil selected from the group consisting of iodine value, slip melting point, and overall saturation level.

14. The microbial oil of claim 7, wherein the oil comprises 10-45% C16 saturated fatty acid.

15. The microbial oil of claim 7, wherein the oil comprises 10-70% C18 unsaturated fatty acid.

16. The microbial oil of claim 7, wherein the oil comprises 3-30% C18 saturated fatty acid.

17. The microbial oil of claim 7, wherein the oil comprises a saponification value similar to that of plant-derived palm oil.

18. The microbial oil of claim 7, wherein the oil comprises a saponification value of 150-210.

19. The microbial oil of claim 7, wherein the oil comprises an iodine value similar to that of plant-derived palm oil.

20. The microbial oil of claim 7, wherein the oil comprises an iodine value of 50-65.

21. The microbial oil of claim 7, wherein the oil comprises a slip melting point similar to that of plant-derived palm oil.

22. The microbial oil of claim 7, wherein the oil comprises a slip melting point of 20° C.-40° C.

23. The microbial oil of claim 7, wherein the oil comprises a saturated fatty acid composition similar to that of plant-derived palm oil.

24. The microbial oil of claim 7, wherein the oil comprises a saturated fatty acid composition of at most 70%.

25. The microbial oil of claim 7, wherein the oil comprises an unsaturated fatty acid composition similar to that of plant-derived palm oil.

26. The microbial oil of claim 7, wherein the oil comprises an unsaturated fatty acid composition of at most 70%.

27. The microbial oil of claim 7, wherein the oil comprises less than 100 ppm of, comprises less than 50 ppm of, or does not comprise a phytosterol.

28. The microbial oil of claim 27, wherein the phytosterol is selected from the group consisting of campesterol, β-sitosterol, stigmasterol.

29. The microbial oil of claim 7, wherein the oil comprises less than 100 ppm of, comprises less than 50 ppm of, or does not comprise cholesterol.

30. The microbial oil of claim 7, wherein the oil comprises less than 100 ppm of, comprises less than 50 ppm of, or does not comprise protothecasterol.

31. The microbial oil of claim 7, wherein the oil does not comprise a pigment.

32. The microbial oil of claim 7, wherein the oil comprises at least one pigment selected from the group consisting of β-carotene, torulene and torulorhodin.

33. The microbial oil of claim 32, wherein the oil comprises each of β-carotene, torulene and torulorhodin.

34. The microbial oil of claim 7, wherein the oleaginous yeast is a recombinant yeast.

35. The microbial oil of claim 7, wherein the oleaginous yeast is of the genus Yarrowia, Candida, Rhodotorula, Rhodosporidium, Metschnikowia, Cryptococcus, Trichosporon, or Lipomyces.

36. The microbial oil of claim 7, wherein the oleaginous yeast is of the genus Rhodosporidium.

37. The microbial oil of claim 7, wherein the oleaginous yeast is of the species Rhodosporidium toruloides.

38. The microbial oil of claim 7, wherein the oil is fractionable.

39. The microbial oil of claim 7, wherein the oil may be fractionated into microbial olein and microbial stearin.

40. The microbial oil of claim 7, wherein the oil may be fractionated into microbial olein and microbial stearin, and wherein each fraction comprises at least 10% of the composition's starting mass.

41. The microbial oil of claim 7, wherein the oil may be fractionated into microbial olein and microbial stearin, and wherein the iodine value (IV) of the fractions differs by at least 10.

42. The microbial oil of claim 7, wherein the oil may be fractionated into microbial olein and microbial stearin, and wherein the IV of the fractions differs by at least 20.

43. The microbial oil of claim 7, wherein the oil may be fractionated into microbial olein and microbial stearin, and wherein the IV of the fractions differs by at least 30.

44. The microbial oil of claim 7, wherein the oil comprises at least 10% w/w C16 saturated fatty acid.

45. The microbial oil of claim 7, wherein the oil comprises at least 10% w/w C18 unsaturated fatty acid.

46. The microbial oil of claim 7, wherein the oil comprises at least 20% w/w C18 unsaturated fatty acid.

47. The microbial oil of claim 7, wherein the oil comprises less than 5% combined C8, C10, C12, C14, and C15 saturated fatty acids.

48. The microbial oil of claim 7, wherein the oil comprises:
less than 10% w/w palmitic-palmitic-palmitic triglycerides;
greater than 15% w/w palmitic-palmitic-oleic triglycerides; and
greater than 15% w/w oleic-oleic-palmitic triglycerides.

49. The microbial oil of claim 48, wherein said palmitic-palmitic-palmitic triglyceride content is between about 0.8% and 1.3% w/w.

50. The microbial oil of claim 48, wherein said palmitic-palmitic-oleic triglyceride content is between about 16.9% and 28.2% w/w.

51. The microbial oil of claim 48, wherein said oleic-oleic-palmitic triglyceride content is between about 15.7% and 26.0% w/w.

52. The microbial oil of claim 48, further comprising a stearic-stearic-oleic triglyceride content of less than 10% w/w and a stearic-oleic-oleic triglyceride content of less than 10% w/w.

53. The microbial oil of claim 52, wherein said stearic-stearic-oleic triglyceride content is between about 1.2% and 1.9% w/w.

54. The microbial oil of claim 52, wherein said stearic-oleic-oleic triglyceride content is between about 3.2% and 5.4% w/w.

55. The microbial oil of claim 48, wherein greater than 40% of said triglycerides have one unsaturated sidechain, and wherein greater than 30% of said triglycerides have two unsaturated sidechains.

56. The microbial oil of claim 48, wherein between 10% and 15% of palmitic and/or stearic fatty acids are located at the sn-2 position of triglyceride molecules.

57. The microbial oil of claim 7 or 48, wherein the oil comprises the following amounts of fatty acids relative to the total fatty acids:
between about 7.0% and 35% stearic acid;
between about 10% and 50% oleic acid; and
between about 8% and 20% linoleic acid.

58. The microbial oil of claim 7, wherein the oil has been refined.

59. The microbial oil of claim 58, wherein the oil has been chemically and/or physically refined.

60. The microbial oil of claim 58 or 59, wherein the oil is deodorized.

61. The microbial oil of claim 58 or 59, wherein the oil is bleached.

62. A derivative of the oil of claim 7, wherein the derivative is a fraction, and wherein the fraction is microbial stearin, microbial olein, microbial soft mid-fraction, microbial super olein, microbial hard mid-fraction, microbial olein, and/or microbial top olein.

63. The microbial stearin of claim 62, wherein the stearin has a slip melting point of greater than 25° C.

64. A food product comprising the microbial olein of claim 62.

65. A blended fat composition, wherein said composition comprises a vegetable oil lipid source, and at least 1% of the edible microbial oil and/or a derivative thereof of claim 62.

66. The blended fat composition of claim 65, wherein the vegetable oil lipid is soybean oil, corn oil, rapeseed oil, canola oil, sunflower oil, safflower oil, coconut oil, rice bran oil, olive oil, sesame oil, flaxseed oil, hemp oil, or cottonseed oil.

67. The blended fat composition of claim 65, wherein the vegetable oil lipid is peanut oil, almond oil, beech nut oil, brazil nut oil, cashew oil, hazelnut oil, macadamia oil, mongongo nut oil, pecan oil, pine nut oil, pistachio oil, walnut oil, or pumpkin seed oil.

68. The blended fat composition of claim 65, wherein the vegetable oil lipid is grapefruit seed oil, lemon oil, apricot oil, apple seed oil, argan oil, avocado oil, or orange oil.

69. The blended fat composition of claim 65, wherein the composition is a cooking oil, frying oil, shortening, margarine, or butter-like product.

70. The blended fat composition of claim 65, wherein the composition does not comprise palm oil or palm kernel oil.

71. A palm oil substitute comprising the edible microbial oil of claim 7, the derivative of claim 62, or the blended fat composition of claim 65.

72. The edible microbial oil of claim 7, the derivative of claim 62, or the blended fat composition of claim 65, wherein the edible oil, derivative, or blended fat composition has one or more characteristics similar to plant-derived palm oil selected from the group consisting of: apparent density, refractive index, oxidative stability, saponification value, unsaponifiable matter, iodine value, slip melting point, fatty acid composition, triglyceride content, overall saturation level, and level of mono- and poly-unsaturated fatty acids.

73. The edible microbial oil of claim 7, the derivative of claim 62, or the blended fat composition of claim 65, wherein the edible oil, derivative, or blended fat composition comprises a slip melting point of 30° C.-40° C.

74. A food product comprising the edible microbial oil of claim 7, the derivative of claim 62, or the blended fat composition of claim 65.

75. The food product of claim 74, wherein the food comprises between 0.1% and 30% edible microbial oil derivative, and/or blended fat composition.

76. The food product of claim 74 or 75, wherein the food product is a nut butter or spread.

77. The food product of claim 74 or 75, wherein the food product is a chocolate product or a chocolate countline product.

78. The food product of claim 74 or 75, wherein the food product is a baked good.

79. The food product of claim 74 or 75, wherein the food product is a meat substitute.

80. The food product of claim 79, wherein the meat substitute is a ground-beef-like product.

81. The food product of claim 74 or 75, wherein the food product is an animal fat substitute.

82. The food product of claim 79, further comprising at least one of an edible gum, a starch, and a gelling agent.

83. The food product of claim 74 or 75, wherein the food product is a cheese-like sub stance.

84. The food product of claim 74 or 75, wherein the food product is a milk-like product.

85. The food product of claim 74 or 75, wherein the food product is an infant formula.

86. The food product of claim 74, wherein the food product does not comprise palm oil or palm kernel oil.

87. The food product of claim 74, wherein the food product does not comprise animal fat.

88. A method for producing an edible microbial oil comprising:
obtaining a whole cell or lysed microbial biomass; and
extracting crude microbial oil from the whole cell or lysed microbial biomass, wherein said extraction process removes toxins and produces a microbial oil safe for human consumption.

89. The method of claim 88, further comprising at least one of physically refining, chemically refining, deodorizing and bleaching the microbial oil.

90. The method of claim 88 or 89, further comprising modifying the microbial oil, wherein said modifying comprises fractionation, interesterification, transesterification, hydrogenation, steam hydrolysis, distillation, saponification, or combinations thereof.

91. The method of claim 90, wherein the method produces a derivative selected from a triglyceride, diglyceride, monoglyceride, free fatty acid, fatty acid salt, glycerin, ester, fatty alcohol, fatty amine, derivative thereof, and combinations thereof.

92. The method of claim 88, wherein the edible microbial oil further comprises ergosterol, β-carotene, torulene, and/or torularhodin.

93. The method of claim 88, wherein the whole cell or lysed microbial biomass is produced by Rhodosporidium toruloides.

94. A method for producing a food product comprising an edible microbial oil and/or a derivative thereof comprising:
obtaining an edible microbial oil, and/or a derivative thereof, wherein said oil is produced from an oleaginous yeast;
using the microbial oil and/or derivative thereof as an ingredient in a food product; and
producing a food product.

95. The method of claim 94, wherein the edible microbial oil is produced by Rhodosporidium toruloides.

96. The method of claim 94 or 95, wherein the food product is a nut butter or spread, a chocolate product, a baked good, a meat substitute, a cheese-like product, a milk-like product, an infant formula, a cooking oil, shortening, margarine, or butter-like product.
